(19) United States
(12) Patent Application Publication
(10) Pub. No.: US 2015/0057808 A1
(43) Pub. Date: Feb. 26, 2015

(54) Systems and Methods for Adaptive Smart Environment Automation

(71) Applicant: Washington State University, Office of Commercialization, Pullman, WA (US)

(72) Inventors: Diane J. Cook, Pullman, WA (US); Parisa Rashidi, Pullman, WA (US)

(21) Appl. No.: 14/500,680

(22) Filed: Sep. 29, 2014

Related U.S. Application Data
(63) Continuation-in-part of application No. 13/858,751, filed on Apr. 8, 2013, now Pat. No. 8,880,378.
Application No. 13/858,751 is a continuation of application No. 12/552,998, filed on Sep. 2, 2009, now Pat. No. 8,417,481.
(60) Provisional application No. 61/096,257, filed on Sep. 11, 2008.

(51) Int. Cl. G05B 13/04; H04L 12/28

(52) U.S. Cl. CPC G05B 13/04; H04L 12/2803
USPC 700/275

(57) ABSTRACT

Several embodiments of systems and methods for adaptive smart environment automation are described herein. In one embodiment, a computer implemented method includes determining a plurality of sequence patterns of data points in a set of input data corresponding to a plurality of sensors in a space. The input data include a plurality of data points corresponding to each of the sensors, and the sequence patterns are at least partially discontinuous. The method also includes generating a plurality of statistical models based on the plurality of sequence patterns, and the individual statistical models corresponding to an activity of a user. The method further includes recognizing the activity of the user based on the statistical models and additional input data from the sensors.

### CROSS-REFERENCE TO RELATED APPLICATIONS

This application is a continuation-in-part of, and claims priority to U.S. application Ser. No. 13/858,751, filed on Apr. 8, 2013, which in turn is a continuation of, and claims priority to U.S. application Ser. No. 12/552,998, filed on Sep. 2, 2009, now U.S. Pat. No. 8,417,481 issue date Apr. 9, 2013, which claims priority to U.S. Provisional Application No. 61/096,257, filed on Sep. 11, 2008, the disclosures of which are incorporated herein by reference in their entirety.

### STATEMENT REGARDING FEDERALLY SPONSORED RESEARCH

This work was supported by National Science Foundation Grants # IIS-0121297 and # IIS-0647705 and National Institutes of Health Subcontract #1R21DA024294-01.

### TECHNICAL FIELD

This technology is related to systems and methods for smart environment automation. In particular, the technology is related to systems and methods for activity recognition and modeling in a smart environment.

### BACKGROUND

There has always been a need for people to live in places that provide shelter, basic comfort, and support. As society and technology advance, there is a growing interest in improving the intelligence of the environments in which we live and work. Recently, various machine learning and artificial intelligence techniques were integrated into home environments equipped with sensors and actuators. However, there is still a need for improving the ease of integrating such smart environment technology into the lifestyle of its residents.

### BRIEF DESCRIPTION OF THE DRAWINGS

FIG. 1 is a schematic diagram of an automation system suitable for use in a smart environment in accordance with embodiments of the technology.

FIG. 2 is a schematic diagram of components of a controller suitable for use in the automation system of FIG. 1 in accordance with embodiments of the technology.

FIG. 3 is a schematic diagram of an example dataset with discontinuous sequences.

FIG. 4 is a schematic diagram illustrating an example of interleaved activity data.

FIG. 5 is a schematic diagram of an example of sensor states in accordance with embodiments of the technology.

FIG. 6 is a diagram of an example of number of discovered patterns versus percentage of top frequent symbols.

FIG. 7 is a diagram of an example of number of pruned patterns versus percentage of top frequent symbols.

FIG. 8 is a diagram of an example of number of discovered clusters versus percentage of top frequent symbols.

FIG. 9 is a bar graph illustrating an example of performance of naive Bayes classifier by activity category.

FIG. 10 is a bar graph illustrating an example of hidden Markov model by activity category.

FIG. 11 is a graph of an example of model accuracy versus number of sensor events.

FIG. 12 is a bar graph illustrating performance comparison of several techniques for recognizing interleaved activities.

FIG. 13 is a bar graph illustrating an example of performance of a hidden Markov model in recognizing activities for multi-resident data.

FIG. 14 is a bar graph illustrating an example of performance of a hidden Markov model in recognizing activities for each resident.

FIG. 15 is a schematic diagram of an automation system suitable for use in a smart environment in accordance with embodiments of the technology.

FIG. 16 illustrates select components of an example wireless local mesh network suitable for use in the automation system of FIG. 15 in accordance with embodiments of the technology.

FIG. 17 illustrates select components of an example controller according to some implementations.

FIG. 18 illustrates select components of an example middleware module according to some implementations.

FIG. 19A is a flow diagram illustrating an example process executed by a controller for cross domain transfer within a smart environment.

FIG. 19B is a flow diagram illustrating an example process executed by a controller for remote collection of activity data within a smart environment.

FIG. 20 is a flow diagram illustrating an example process executed by a controller for registering a system component within a smart environment.

FIG. 21 is a flow diagram illustrating an example process executed by a controller for admitting a device to a local network within a smart environment.

FIG. 22 is a flow diagram illustrating an example process executed by a controller for requesting data from a server within a smart environment.

FIG. 23 illustrates select components of an example portable device according to some implementations.

FIG. 24 is a flow diagram illustrating an example process executed by a portable device for registering a system component within a smart environment.

FIG. 25 is a flow diagram illustrating an example process executed by a portable device for cross domain transfer and activity tracking within a smart environment.

FIG. 26 illustrates select components of one or more example server host computing devices according to some implementations.

### DETAILED DESCRIPTION SECTION

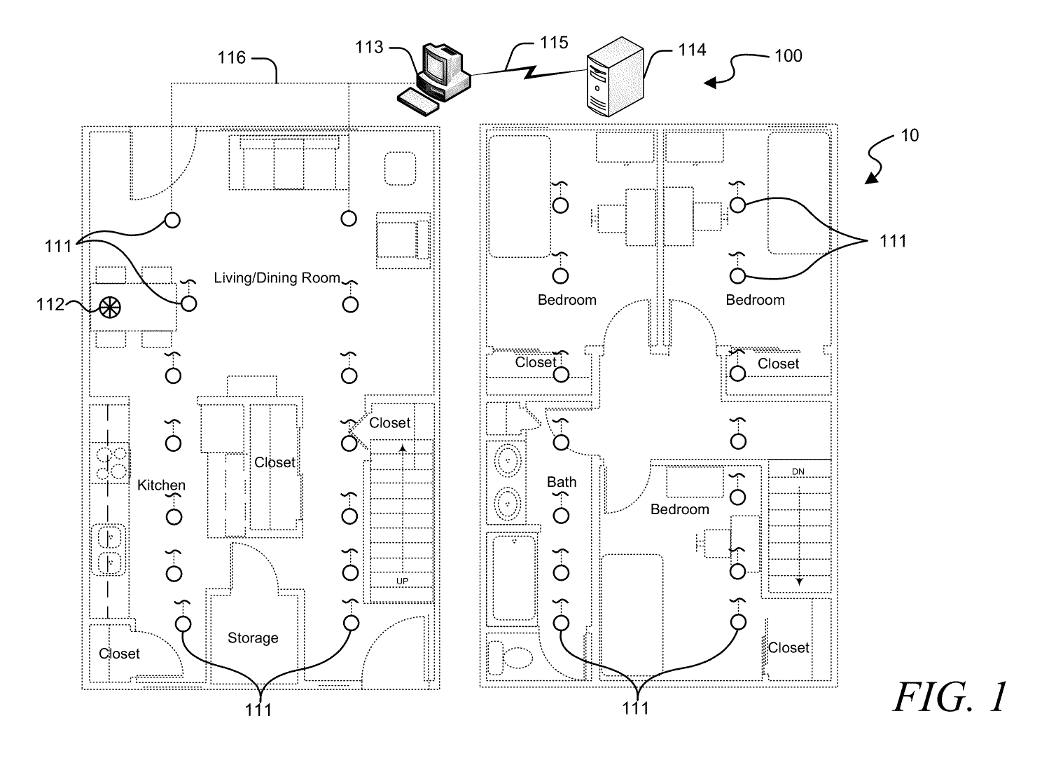

This disclosure describes systems and methods for smart environment automation. In particular, several embodiments are related to systems and methods for discovering and/or recognizing patterns in resident behavior and generating automation polices based on these patterns. As used herein, a “smart environment” generally refers to an environment associated with systems and components (both software and hardware) that can acquire and apply knowledge about physical settings and activity patterns of residents in the environment. Several of the details set forth below are provided to describe the following embodiments and methods in a manner sufficient to enable a person skilled in the relevant art to practice, make, and use them. Several of the details and advantages described below, however, may not be necessary to practice certain embodiments and methods of the technology. A person of ordinary skill in the relevant art, therefore, will understand that the technology may have other embodiments with additional elements, and/or may have other embodiments without several of the features shown and described below with reference to FIGS. 1-26.

FIG. 1 is a schematic diagram of an automation system 100 suitable for use in a smart environment 10 in accordance with embodiments of the technology. As shown in FIG. 1, the smart environment 10 includes a three bedroom apartment with sensors 111 and control elements 112 installed therein, a controller 113 operatively coupled to the sensors 111 and the control elements 112, and optionally a server 1504 (e.g., a backend network server) coupled to the controller 113 via a network 115 (e.g., an intranet or internet). In other embodiments, the smart environment 10 can also include an office space, a warehouse, and/or other types of environment with additional and/or different electronic and/or mechanical components.

The sensors 111 can include a motion sensor (e.g., ultraviolet light sensors, laser sensors, etc.), a positional sensor (e.g., a position switch on a door, a cabinet, or a refrigerator), an item sensor (e.g., a capacitive sensor for detecting a touch by a user), a temperature sensor, a water flow sensor, a vibration sensor, an accelerometer, a shake sensor, a gyroscope, a global positioning system sensor (“GPS”) and/or other suitable types of sensors. The control elements 112 can include a switch (e.g., an electrical switch to turn on a light), an actuator (e.g., an electric actuator to open a door), and/or other types of components capable of being controlled by the controller 113. The sensors 111 and the control elements 112 may be operatively coupled to the controller 113 via wired, wireless, and/or other suitable communication links such as local network 116.

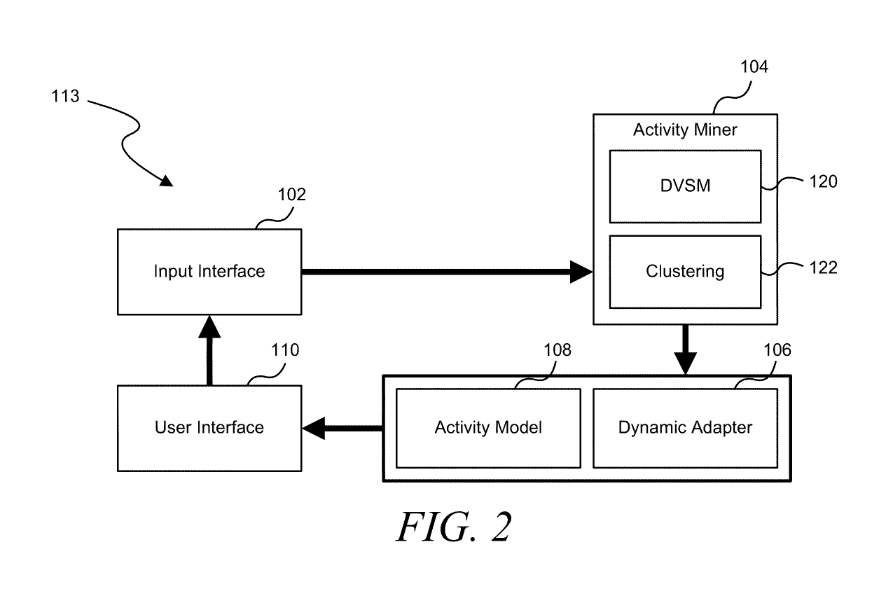

The controller 113 can be configured to recognize activities of a resident in the smart environment 10, and can be configured to automate the operations of the control elements 112 based on the recognized activities (e.g., by turning on a light, opening a door, etc.). The controller 113 can include a personal computer, a programmable logic controller, and/or other types of computing devices. The controller 113 can include a CPU, memory, and a computer-readable storage medium (e.g., a hard drive, a CD-ROM, a DVD-ROM, and/or other types of suitable storage medium) operatively coupled to one another. The computer-readable storage medium can store instructions that may be presented to the CPU for execution. The instructions may include various components described in more detail below with reference to FIG. 2.

As shown in FIG. 2, the controller 113 can include an input interface 102, an activity miner 104, a dynamic adapter 106, an activity model 108, and a user interface 110 operatively coupled to one another. In certain embodiments, the input interface 102 may include an analog input module, a discrete input module, and/or other suitable hardware components for receiving sensor data. In other embodiments, the input interface 102 may include an Ethernet driver, a USB driver, and/or other suitable software components. In further embodiments, the input interface 102 may include both hardware and software components.

Several embodiments of the activity miner 104, the dynamic adapter 106, the activity model 108, and the user interface 110 are described in greater detail below. In certain embodiments, each of these components may be a computer program, procedure, or process written as source code in a conventional programming language, such as the C++ programming language, and may be presented for execution by the CPU of the controller 113. In other embodiments, some of these components may be implemented as ASIC's, field-programmable gate arrays, and/or other hardware components.

### Activity Miner

The activity miner 104 can be configured to analyze collected sensor data from the smart environment 10 (FIG. 1) to discover frequent and periodic activity sequences. Conventional techniques for mining sequential data include mining frequent sequences, mining frequent patterns using regular expressions, constraint-based mining, and frequent-periodic pattern mining. One limitation of these techniques is that they do not discover discontinuous patterns that may indicate a particular resident activity. For example, when a resident prepares a meal, the cooking steps do not always follow the same strict sequence; but rather may change and interleave with other steps that may not consistently appear each time.

Discovering Frequent Discontinuous Sequences

Several embodiments of the activity miner 104 include a Discontinuous Varied-Order Sequential Mining module (DVSM) 120 operatively coupled to a clustering module 122 to identify sensor event sequences that likely belong together and appear with enough frequency and regularity to comprise an activity that can be tracked and analyzed. In other embodiments, the activity miner 104 may also include other suitable modules in addition to or in lieu of the DVSM 120 and the clustering module 122.

The DVSM 120 may be configured to find sequence patterns from discontinuous instances that might also be misplaced (exhibit varied order). For example, the DVSM 120 is configured to extract the pattern <a b> from instances {b x c a}, {a b q}, and {a u b}. The order of items is considered as they occur in the data. Unlike many other sequence mining techniques, a general pattern that comprises all variations of a single pattern that occur in the input dataset D is reported; also reported is the core pattern that is present in all these variations. For a general pattern a, the i^{th} variation of the pattern is denoted as aᵢ, and the core pattern as a_{c}. Each single component of a pattern is referred to as an event (such as “a” in the pattern <a b>).

In accordance with several embodiments, to find discontinuous order-varying sequences from the input data D, a reduced dataset Dᵣ containing all symbols in D that occur with a frequency greater than fₘᵢₙ may be created. To obtain a value for fₘᵢₙ, the top α % frequent symbols are considered, and fₘᵢₙ is set to the minimum frequency from this subset.

Next, a window is moved across Dᵣ. The window is initialized to a size of 2 or other suitable values and may be increased by one each iteration. While moving the window across Dᵣ, all patterns that are approximate permutations of each another are saved as variations of the same general pattern, e.g., in a hash table. To see if two patterns should be considered as permutations of the same pattern, the Levenshtein distance may be used and an acceptable threshold on this distance, ζ may be imposed. The frequency f(α) of the discovered general pattern a is calculated as a sum of the frequencies of α's order variations. The general pattern α is defined to be the sequence permutation that occurs most often in the dataset.

General patterns may be identified if they satisfy the inequality shown in Equation 1 below. In this equation DL represents the description length of the argument. C is a minimum compression value threshold.

$$\frac{DL ( D )}{DL ( a ) + DL ( D \vert a )} > C \qquad ( 1 )$$

The pattern which best describes a dataset is the one which maximally compresses the dataset by replacing instances of the pattern with pointers to the pattern definition. However, because discontinuities are allowed to occur, each instance of the pattern may be encoded not only with a pointer to the pattern definition but also with a discontinuity factor, Γ. The discontinuity of a pattern instance, Γ(aᵢ), may be calculated as the number of bits required to express how the pattern varies from the general definition.

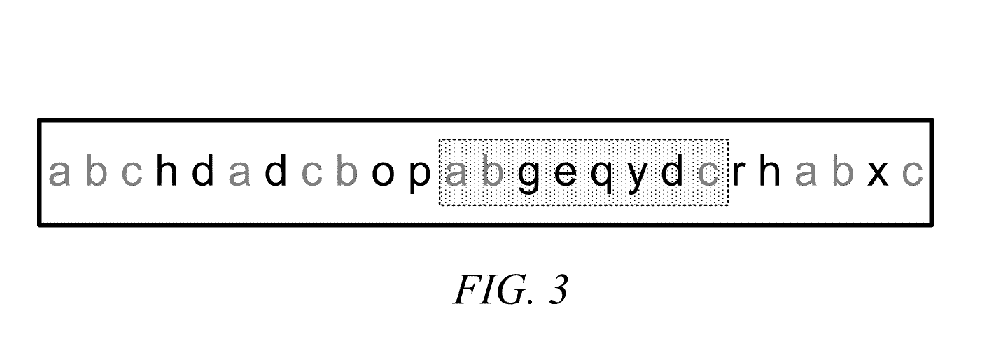

FIG. 3 is a schematic diagram of an example dataset for illustrating the foregoing pattern identification technique. As shown in FIG. 3, the dataset includes a general pattern <a b c>. An instance of the pattern is found in the sequence {a b g e q y d c} where symbols “g e q y d” separate the pattern subsequences {a b} and {c}.

The discontinuity of pattern a, referred to as Γₐ, may be defined as a weighted average of discontinuity variations. The discontinuity of a variation may be defined as the average discontinuity of its instances, which is then weighted by the number of instances of the pattern that occur in the data. Based on this definition of discontinuity, Equation 1 may be rewritten as Equation 2 below:

$$\frac{DL ( D )}{( DL ( a ) + DL ( D \vert a ) ) * {Γ}_{a}} > C \qquad ( 2 )$$

Patterns that satisfy the inequality in Equation 2 may be flagged as potential candidate patterns. Patterns of increasing length may be identified by increasing the window's size via iteration. During each iteration, in certain embodiments, redundant subpatterns; i.e., those patterns that are totally contained in another larger core pattern may be eliminated. By eliminating the redundant sub-patterns, the number of discovered patterns may be reduced. In one embodiment, the window size may be increased each iteration until a user-specified number of iterations has been reached. In other embodiments, the window size may be increased each iteration until no more candidate patterns are found.

Clustering Sequences

The activity miner 104 can also include a clustering module 122 configured to group patterns that represent particular activities and their instances. For example, the clustering module 122 can group the set of discovered patterns, P, into a set of clusters, A. The resulting sets of clusters represent the activities that may be modeled, recognized, and tracked. In one embodiment, the clustering module 122 can use a standard k-means clustering technique. In other embodiments, the clustering module 122 can also use hierarchical clustering that is either agglomerative (bottom up) or divisive (top down) and/or other suitable techniques.

In certain embodiments, patterns discovered by the DVSM 120 can include sensor events. In one embodiment, the clustering module 122 considers the pattern as composed of states. States may correspond to the pattern events but can also include additional information such as the type and duration of the sensor events. In addition, several states may be combined to form a new state. For example, consecutive states with sensors of the same type may be combined to form a new state in order to have a more compact representation of activities and/or to allow similar activities to be more easily compared.

To calculate the similarity between two activities x and y, the clustering module 122 may compute the edit distance between the activity sequences, or the sequence of steps that comprise the activity. In particular, the number of edit operations that are required to make activity x equal to activity y may be computed. The weighted edit operations may include adding a step, deleting a step, re-ordering a step, or changing the attributes of a step (i.e., step duration).

A representative cluster may be defined as the activity that has the highest degree of similarity with all other activities in the same cluster, or equivalently the lowest combined edit distance to all other activities in the cluster. Each representative cluster represents a class of similar activities, considerably forming a compact representation of all the activities in the cluster. The activities represented by the final set of clusters are those that are modeled and recognized by the automation system 100 (FIG. 1).

### Activity Model

The activity model 108 can then build models for the sequences that provide a basis for learning automation policies. Several embodiments of the activity model 108 are configured to model smart environmental activities and sequences reported by the activity miner 104 and then to use the model to identify activities that may be automated (e.g., by controlling the control elements 112 in FIG. 1) and/or monitored. A range of different probabilistic models may be used in the activity model 108. Suitable examples include Dynamic Bayes Networks, Naïve Bayes Classifiers, Markov models, and hidden Markov models.

A great deal of variation may exist in the manner in which the activities are performed. This variation is increased dramatically when the model used to recognize the activity needs to generalize over more than one possible resident. To address such difficulty, in several embodiments, the activity model 108 includes a hidden Markov model to determine an activity that most likely corresponds to an observed sequence of sensor events.

A hidden Markov model (HMM) is a statistical model in which the underlying model is a stochastic process that is not observable (i.e. hidden) and is assumed to be a Markov process which can be observed through another set of stochastic processes that produce the sequence of observed symbols (or sensor data). A HMM assigns probability values over a potentially infinite number of sequences. Because the probability values must sum to one, the distribution described by the HMM is constrained. Thus, the increase in probability values of one sequence is directly related to the decrease in probability values for another sequence.

Given a set of training data, the activity model 108 uses the sensor values as parameters of a hidden Markov model. Given an input sequence of sensor event observations, the hidden Markov model may be used to find the most likely sequence of hidden states, or activities, which could have generated the observed event sequence. While a skilled artisan could use both forward and backward probability calculations, in the illustrated embodiment, Equation (3) below may be used to identify this sequence of hidden states:

$$arg {max}_{{x}_{1} … {x}_{t}} P ( {y}_{1} , … , {y}_{t} , {y}_{t + 1} \vert {x}_{1 : t + 1} ) \qquad ( 3 )$$

The activity model 108 can recognize interleaved activities using HMM's. The conditional probability distribution of any hidden state depends only on the value of the preceding hidden state. The value of an observable state depends only on the value of the current hidden state. The observable variable at time t, namely xₜ, depends only on the hidden variable yₜ at that time. In certain embodiments, a HMM may use three probability distributions: the distribution over initial states Π={πₖ}, the state transition probability distribution A={aₖₗ}, with aₖₗ=p(yₜ=I/yₜ₋₁=k) representing the probability of transitioning from state k to state I; and the observation distribution B={bᵢₗ}, with bᵢₗ=p(xₜ=i/yₜ=I) indicating the probability that the state I would generate observation xₜ=i. These distributions may be estimated based on the relative frequencies of visited states and state transitions observed in a training period.

The activity model 108 may be configured to identify the sequence of activities (i.e., the sequence of visited hidden states) that corresponds to a sequence of sensor events (i.e., the observable states). The activity model 108 can calculate based on the collected data, the prior probability (i.e., the start probability) of every state which represents the probability of which state the HMM is in when the first sensor event is detected. For a state (or activity) a, this is calculated as the ratio of instances for which the activity label is a.

The activity model 108 may also calculate the transition probability which represents the change of the state in the underlying Markov model. For any two states a and b, the probability of transitioning from state a to state b is calculated as the ratio of instances having activity label a followed by activity label b, to the total number of instances. The transition probability signifies the likelihood of transitioning from a given state to any other state in the model and captures the temporal relationship between the states. Lastly, the emission probability represents the likelihood of observing a particular sensor event for a given activity. This may be calculated by finding the frequency of every sensor event as observed for each activity.

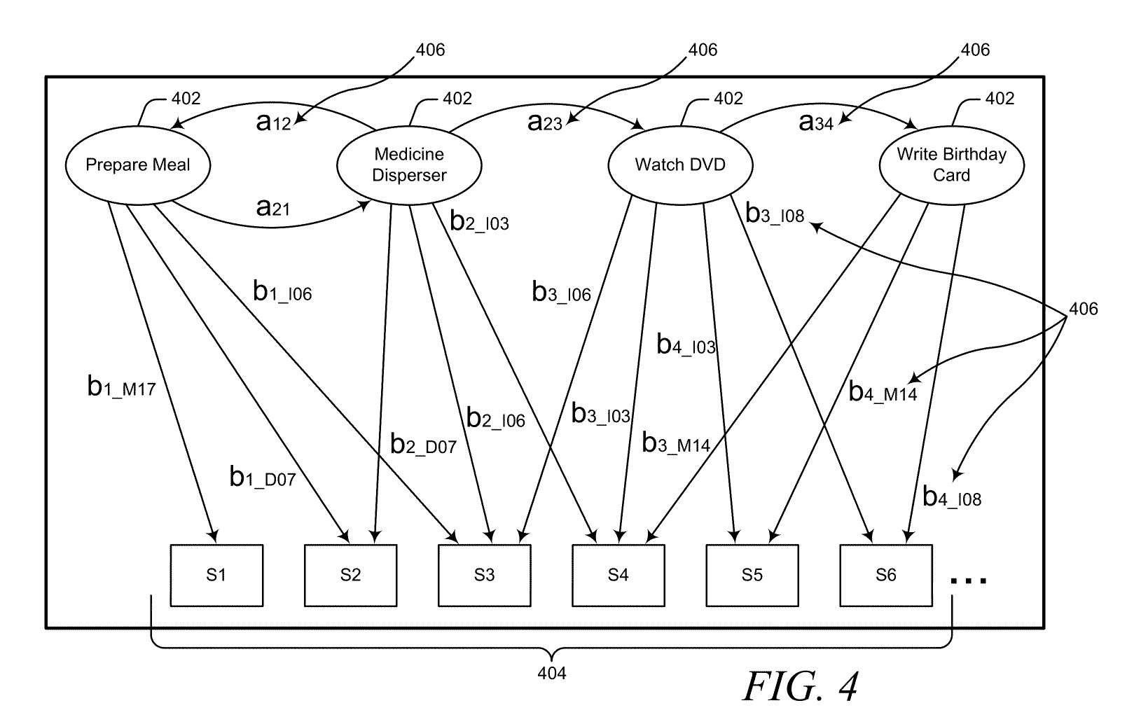

FIG. 4 shows a portion of an example of a generated HMM for multiresident activities. As shown in FIG. 4, the HMM can include hidden nodes 402 (associated with a particular resident activity) associated with one another and with sensor events 404 via a plurality of corresponding probabilities 406. For example, the hidden node 402 “Prepare Meal” is associated with another hidden node 402 “Medicine Disperser” via a probability a21 that may be obtained empirically from training data. The probability a21 represents the probability of the resident transitioning from “Prepare Meal” to “Medicine Disperser” when the current state is “Prepare Meal.” The hidden node 402 “Prepare Meal” can also be associated with a sensor event S1 (e.g., a motion sensor) via a probability b₁_{_{—}}_{M17}. The probability b₁_{_{—}}_{M17} represents the probability that the sensor event (i.e., motion detection at S1) is caused by the resident's activity of “Prepare Meal.”

Selecting Actions for Automation

After the activity model is constructed, in several embodiments, the activity model 108 optionally schedules activities for automation such that 1) the most-predicted activities are given a greater chance of being automated, 2) less likely activities retain a chance of being automated, and 3) the temporal relationships between activities are preserved (i.e., activities are scheduled as a maximal non-conflicting set of actions).

The probability of selecting a particular activity A for automation is thus calculated as shown in Equation 4, where k is a constant and β*D(A) is a term which is added to favor recently added sequences.

$$P ( A ) = \frac{{k}^{EU ( A ) + β * D ( A )}}{{\sum }_{j} {k}^{E ( j ) + β * D ( j )}} \qquad ( 4 )$$

The initial value of k can be relatively high which allows for exploration, but over time may decrease so that the automation becomes more predictable as the desirability of the activities is established.

In certain embodiments, the activity model 108 may optionally select activities for automation according to their expected utility. At any given time, the automation system 100 may select an event to perform and maximize the expected utility based on the feedback the resident has provided for the automated sequences using the formula shown in Equation 5:

EU(A)=P_{T}(A) Q̅(A) (5)

In Equation 4, the value Q̅(A) of activity A is defined as the average of the values for all of the events comprising the activity. The probability P_{T}(A) represents the probability of transitioning to activity A.

### Dynamic Adaptation

The dynamic adapter 106 can be configured to detect changes in resident behaviors and modify the automation policies. In several embodiments, the dynamic adapter 106 may adapt in four ways. First, a resident can modify, delete, or add automation activities using the user interface 110. Second, the resident can rate automation activities based on their preferences. Third, the resident can highlight an activity in the user interface 110 for observation, and allow the automation system 100 to automatically detect changes and modify the model for that activity. Finally, the dynamic adapter 106 can passively monitor resident activities and if a significant change in events occurs may automatically update the corresponding activity model. In other embodiments, the automation system 100 can also adapt in other ways and/or a combination of the foregoing adaptation approaches.

In several embodiments, the automation system 100 provides an option to automatically detect changes in a specified activity to remove the burden of explicit user manipulation. When an activity is highlighted for monitoring, several embodiments of the dynamic adapter 106 can collect event data and mine the sequences, as was initially done by the activity miner 104. The activity miner 104 can be looking for potentially-changed versions of a specific activity. These changes may include new activity start times, durations, triggers, periods, or structure. Structure change can be detected by finding new patterns of activity that occur during the times that the automation system 100 expects the old activity to occur. Other parameter values may be changed if an activity occurs that matches the structure of the highlighted activity but the parameters (e.g., timing, triggers) have changed. All changes above a given threshold may be considered as different versions of the pattern and may be shown to the user through the user interface 110.

In addition, the dynamic adapter 106 can automatically mine collected data at periodic intervals (e.g., every three weeks) to update the activity models. New and revised activities are reflected in the activity models using update procedures similar to the ones that were already described. For activities that are already in the activity model, a decay function, shown in Equation 6, may be applied that reduces the value of an activity by a small amount ε at each step θ.

$${Q}_{l}^{π} = {Q}_{l}^{π} - \frac{ɛ * Δ {t}_{d}}{θ} \qquad ( 6 )$$

The decay effect allows activities that have not been observed over a longer period of time to receive smaller values and eventually to be forgotten.

### User Interface

Users can explicitly request automation changes through the user interface 110. In several embodiments, the user interface 110 can be a discrete event simulator where each object is a self-descriptive, iconic representation of an item in the environment. Using data collected from motion sensors 110, the controller 113 can display the resident's location, visualized as animated footprints on the map. Several types of objects in the environment include: static, dynamic and interface. While static object states do not change, dynamic objects can change state. Interface objects allow either users or other external entities to interact with the simulation. Each object possesses attributes, a number of possible states, and a specific functionality.

The user interface 110 allows the resident to control events that are distributed across time as well as the resident's living space. The user interface 110 may be configured to create a temporal framework and spatial framework to allow the resident to perceive, comprehend, and ultimately modify events occurring in the physical world around the resident. In such a schema, the floor map provides a spatial framework and the temporal constraints are displayed as an animation of event sequences where the direct mapping of the order of events in the physical world maps to the order of the displayed elements.

### EXAMPLES

### Example 1

### Activity Miner

Several embodiments of the automation system 100 were evaluated using generated data and data collected in a three-bedroom apartment generally similar to that shown in FIG. 1. The apartment was equipped with motion sensors on the ceiling approximately 1 meter apart throughout the space. In addition, sensors were installed to provide ambient temperature readings and readings for hot water, cold water, and stove burner use. Voice over IP using the Asterisk software captured phone usage. Contact switch sensors monitored the open/closed status of doors and cabinets, and pressure sensors monitored usage of key items such as the medicine container, cooking phone, and phone book. Sensor data were captured using a sensor network and stored in a database such as a Sal database. Middleware using a jabber-based publish/subscribe protocol as a lightweight platform and language-independent middleware were used to push data to client tools.

Normal Activity Discovery

For the first experiment, the activity miner 104 was applied to data collected in the apartment. Specifically, data for a collection of specific, scripted activities were collected and analyzed using the activity miner 104. To provide physical training data, 24 Washington State University undergraduate students were recruited from the psychology subject pool into the apartment. One at a time, the students performed the following five activities:
1) Telephone Use: Looked up a specified number in a phone book, called the number, and wrote down the cooking directions given on the recorded message.
2) Hand Washing: Washed hands in the kitchen sink.
3) Meal Preparation: Cooked oatmeal on the stove according to the recorded directions, added brown sugar and raisins (from the kitchen cabinet) once done.
4) Eating and Medication Use: ate the oatmeal together with a glass of water and medicine (a piece of candy).
5) Cleaning: Cleaned and put away the dishes and ingredients.

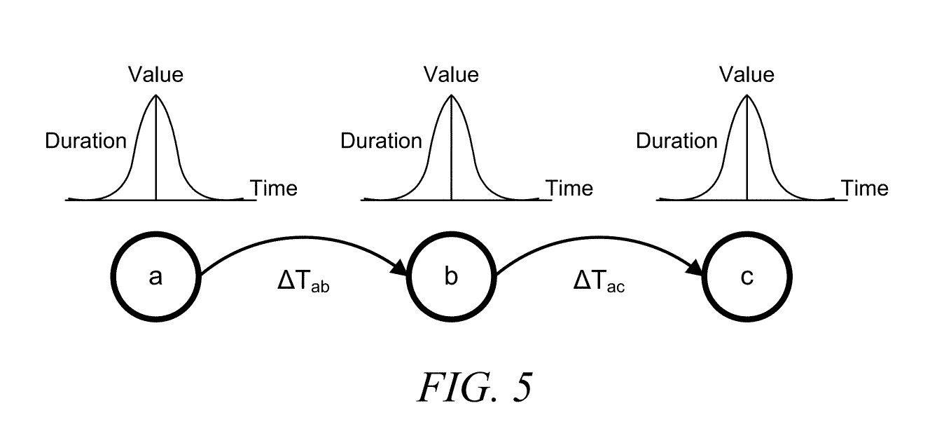

FIG. 5 is a schematic diagram of an example of sensor states in accordance with embodiments of the technology. As shown in FIG. 5, sensor states a, b, and c with their corresponding value distributions are recorded. Also recorded is the elapsed time between two states. For example, a first elapsed time ΔTab between state a and state b and a second elapsed time ΔTac between state b and state c. In certain embodiments, the elapsed time may be used to recognize different activities when the activities involve similar or the same sequence of sensor events. For example, a sensor event may indicate a faucet is opened. The elapsed time may be used to identify whether a resident is washing hands or washing dishes because washing dishes would typically involve a longer elapsed time.

The activity miner 104 was applied to the sensor data collected for the normal activities. Specifically, repeating sequential patterns were discovered in the sensor event data and then clustered into five clusters and determined if the discovered activities were similar to those that were pre-defined to exist in the sensor data. In these experiments, the minimum compression threshold, C, was set to 0.3, the minimum symbol frequency, fmin, was set to 2, and the permutation threshold, S, was set to 0.5. When analyzing all collected sensor events, DVSM 120 discovered 21 general patterns with lengths varying from 7 to 33 events, and comprising up to 4 variations for each pattern. The DVSM 120 was able to find repetitive patterns in a compact form from 120 activity sensor streams, despite considerable intra-subject variability.

Next, the discovered activities can be clustered. The attributes considered in this set of activities were duration of states and frequency. Averaging over 10 runs, the activity miner 104 found cluster representatives corresponding to the original activities for 76% of the participant data files with a standard deviation of 12.6% (discovering 100% for some participants). In addition, 77.1% of the total activity sensor event sequences were assigned to the correct clusters (with a standard deviation of 4.8%).

Interweaved Activity Discovery

In the second experiment, the activities were interwoven together when performed. The activity miner 104 was still able to discover many of these pre-selected activities. Twenty two additional volunteer participants were recruited to perform a series of activities in the apartment, one at a time:
1) Fill medication dispenser: Here the participant removed the items from the kitchen cupboard and filled the medication dispenser using the space on the kitchen counter.
2) Watch DVD: The participant selected the DVD labeled “Good Morning America” located on the shelf below the TV and watched it on the TV. After watching it, the participant turned off the TV and returned the DVD to the shelf.
3) Water plants: For this activity, the participant took the watering can from the supply closet and lightly watered the 3 apartment plants, 2 of which were located on the kitchen windowsill and the third was located on the living room table. After finishing, he/she emptied any extra water from the watering can into the sink and returned the watering can to the supply closet.
4) Converse on Phone: Here the participant answered the phone when it rang and hung up after finishing the conversation. The conversation included several questions about the DVD show that the participant watched as part of activity 2.
5) Write Birthday Card: The participant wrote a birthday wish inside the birthday card and filled out a check in a suitable amount for a birthday gift, using the supplies located on the dining room table. He/she then placed the card and the check in an envelope and appropriately addressed the envelope.
6) Prepare meal: The participant used the supplies located in the kitchen cupboard to prepare a cup of noodle soup according to the directions on the cup of noodle soup. He/she also filled a glass with water using the pitcher of water located on the top shelf of the refrigerator.
7) Sweep and dust: For this task, the participant swept the kitchen floor and dusted the dining and the living room using the supplies located in the kitchen closet.
8) Select an outfit: Lastly, the participant selected an outfit from the clothes closet to be worn by a male friend going on an important job interview. He/she then laid out the selected clothes on the living room couch.

The participants performed all of the foregoing activities by interweaving them in any fashion they liked with a goal of being efficient in performing the tasks. The order in which activities were performed and were interwoven was left to the discretion of the participant. Because different participants interwove the tasks differently, the resulting data set was rich and complex.

Similar to the previous experiment, the DVSM 120 was run on the data containing 176 activities, and then clustered the discovered patterns. The parameter values were defined as in the previous experiment, with the exception that the number of clusters was set to 8 to be equal to the new number of pre-defined activities. When it was applied to the collected sensor data, DVSM 120 was able to find 32 general patterns with lengths varying from 6 to 45 events, and comprising up to 8 activity variations. Averaging over 10 runs, the activity miner 104 found cluster representatives corresponding to the original activities in 87.5% of the participant datasets. Surprisingly, this number is higher than in the previous experiment. From the dataset, 92.8% of the activity sensor event sequences were assigned to the correct clusters.

Long Term Activity Discovery

A possible use of the present technology is to perform activity discovery during a time when a resident is healthy and functionally independent, to establish a baseline of normal daily activities. In a third experiment, three months of daily activity data from the smart apartment 10 were collected while two residents lived there and performed their normal daily routines. Sensor data were collected continuously, resulting in 987,176 sensor events. The activity miner 104 was applied to the first month of collected data. The parameter settings were similar to the previous experiments with the exceptions that the maximum sequence length was set to 15, and the top percentage (α) of frequent symbols was varied in pattern discovery.

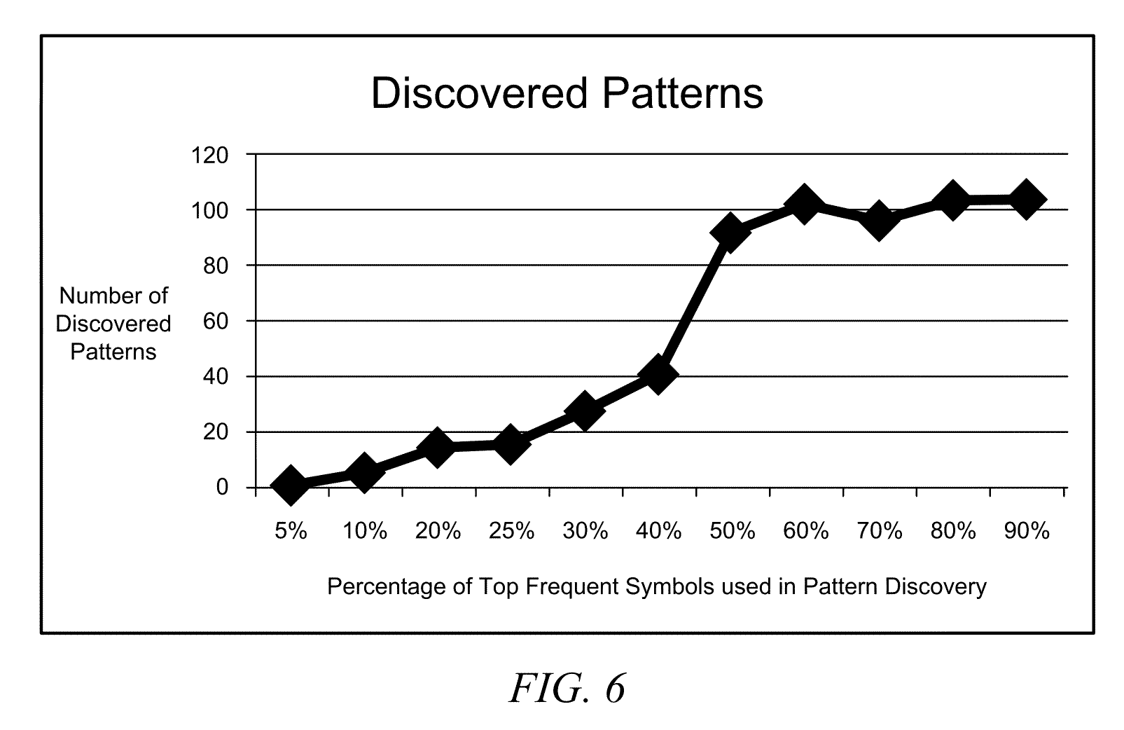

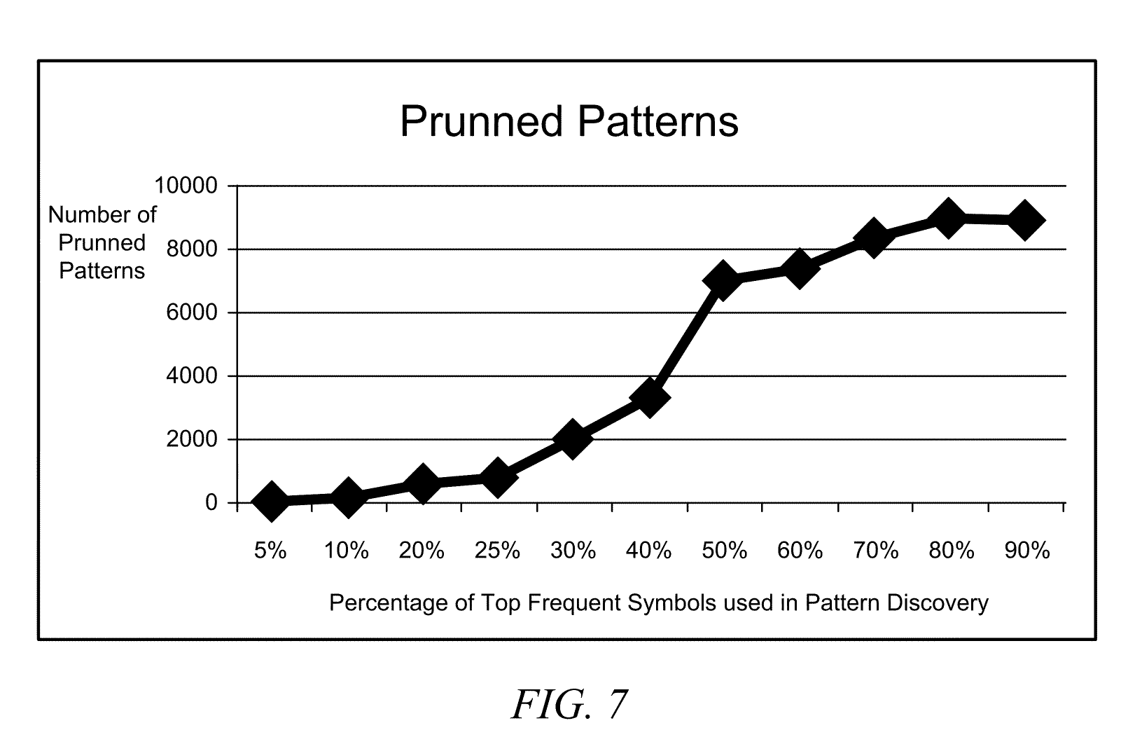

It is believed that increasing the value of α results in discovering more patterns, as a wider range of frequent symbols are involved, but after the value exceeds a certain threshold (in our experiments 50%), fewer new patterns are discovered. As FIG. 6 shows, the number of patterns ranged from 2 (α=5%) to 110 (α=60%). As shown in FIG. 7, the pruning process removed a large number of patterns, considerably reducing the number of redundant patterns.

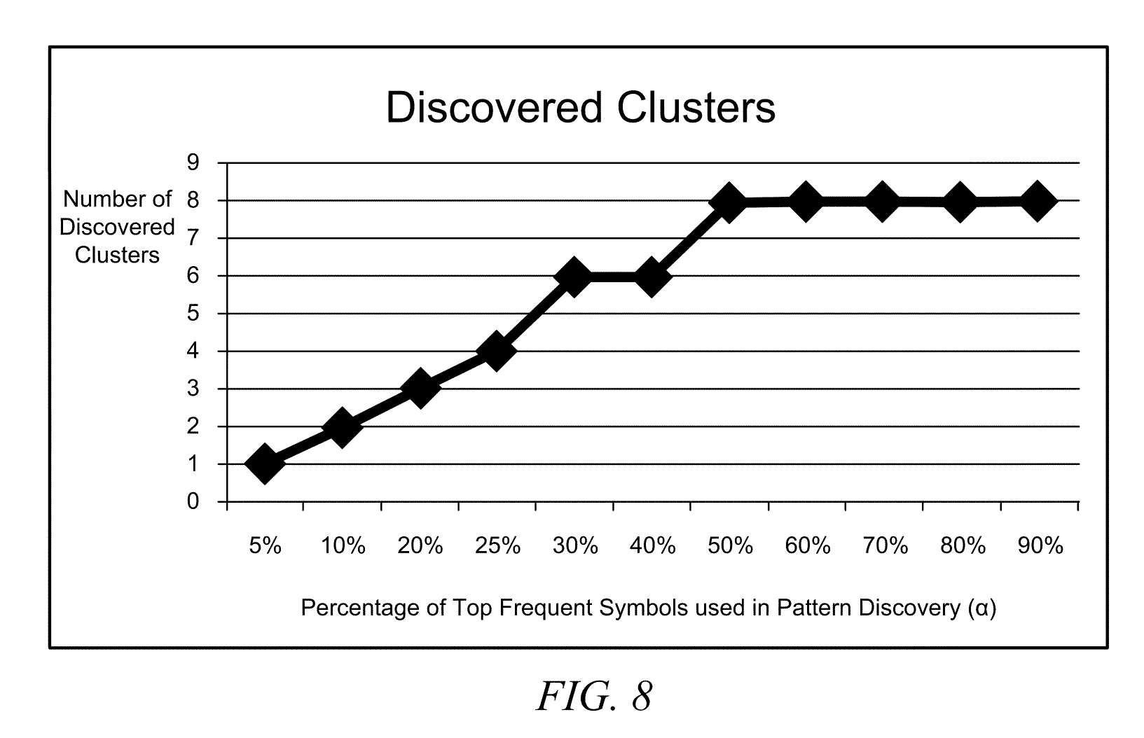

As shown in FIG. 8, after discovering sequential patterns in the sensor event data, the discovered patterns were clustered, with k set to a maximum of 8 clusters. For smaller values of α, the clusters tend to merge together. As the value of α increases and therefore the number of discovered patterns increase, more distinguished clusters were formed. After a threshold value of a was reached (α=50%), the number of clusters remained virtually constant.

### Example 2

### Activity Models

HMM and Naive Bayes Classifier

20 volunteer participants were recruited to perform the foregoing series of activities in the smart apartment, one at a time. Each participant first performed the separated activities in the same sequential order. Then, the participants were performed all of the activities again while interweaving them in any fashion.

The data collected during these tasks were manually annotated with the corresponding activity for model training purposes. Specifically, each sensor event was labeled with the corresponding activity ID. The average times taken by the participants to complete the eight activities were 3.5 minutes, 7 minutes, 1.5 minutes, 2 minutes, 4 minutes, 5.5 minutes, 4 minutes and 1.5 minutes, respectively. The average number of sensor events collected for each activity was 31, 59, 71, 31, 56, 96, 118, and 34, respectively.

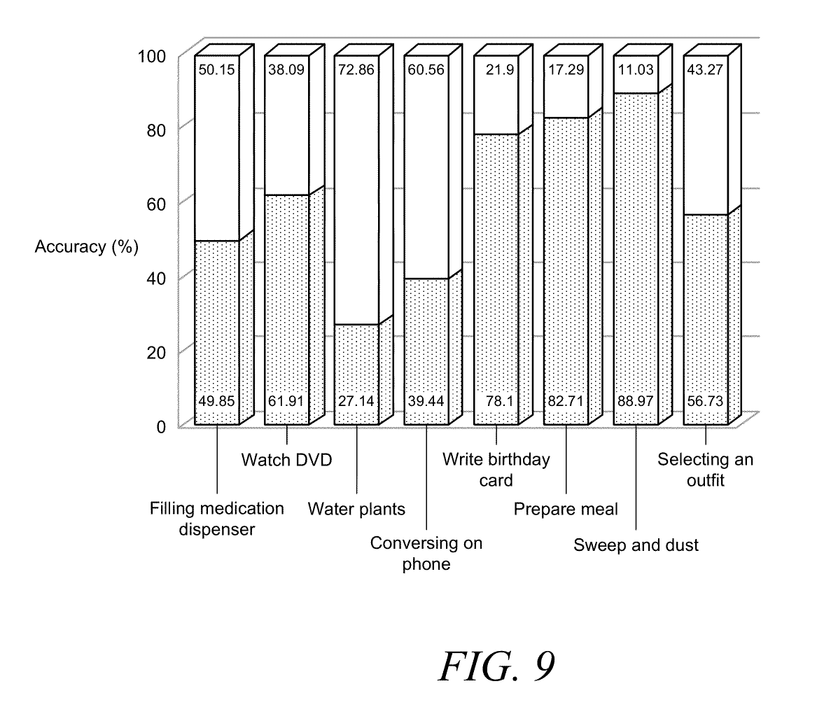

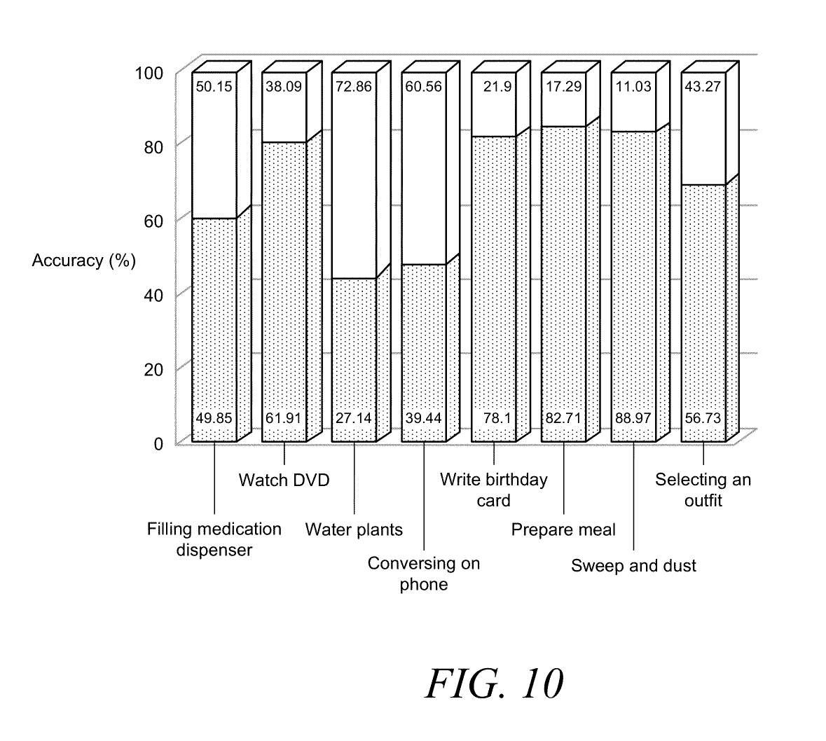

The data collected were used to train a naïve Bayes classifier and HMM. The naïve Bayes classifier achieved an average recognition accuracy of 66.08% as shown in FIG. 9. The HMM achieved an average recognition accuracy of 71.01%, which represents a significant improvement of 5% accuracy over the naïve Bayes model at p<0.04, as shown in FIG. 10.

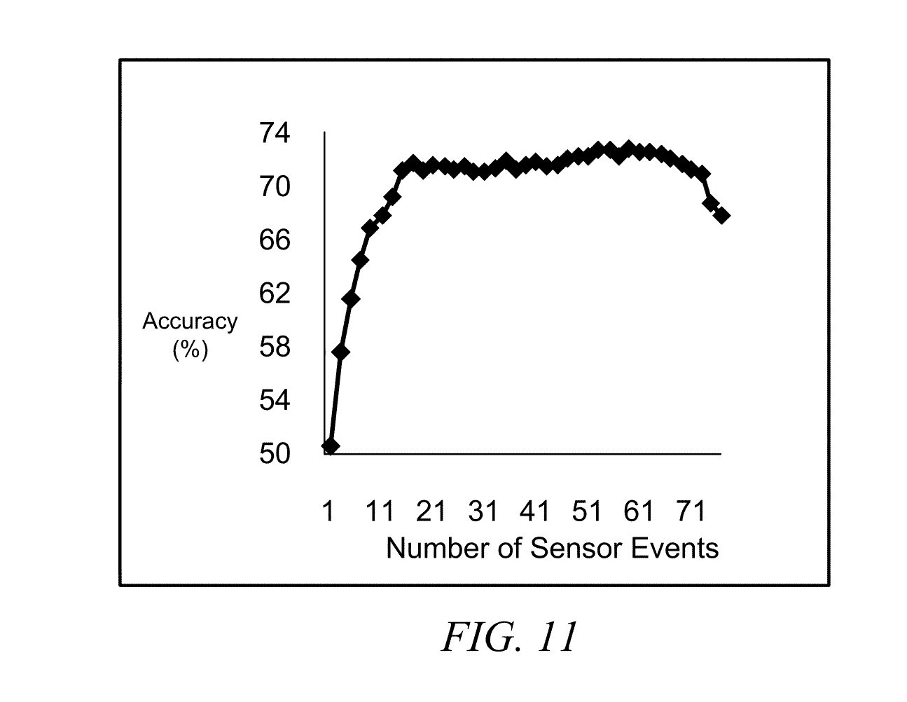

FIG. 11 shows the accuracy of the HMM for various count-based window sizes. The performance of the HMM improves as the window size increases. Performance peaks at a window size of 57 sensor events, which was the size that the activity miner used for the activity recognition. Performance starts falling again when the window size was too large.

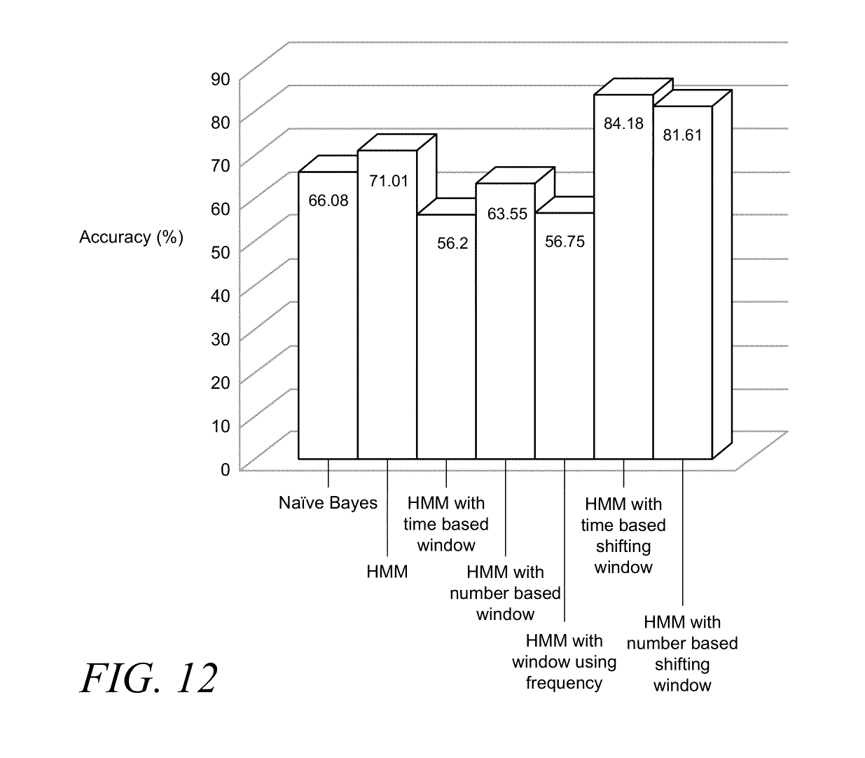

In addition to applying a moving window, the activity labeling approach was also changed. Instead of labeling each sensor event with the most probable activity label, the activity label for the entire window was determined. Then, the last sensor event in the window was labeled with the activity label that appears most often in the window (a frequency approach) and the window was moved down the stream by one event to label the next event. Alternatively, all sensor events in the window may be labeled with the activity label that most strongly supports the sequence and then the window may be shifted to cover a nonoverlapping set of new sensor events in the stream (a shifting window approach). FIG. 12 compares the performance of the foregoing techniques.

HMM with Multiple Residents

40 volunteer participants were recruited to perform a series of activities in the smart apartment. The smart apartment was occupied by two volunteers at a time performing the assigned tasks concurrently. The collected sensor events were manually labeled with the activity ID and the person ID. For this study, 15 activities were selected:

Person A:
1. Filling medication dispenser (individual): for this task, the participant worked at the kitchen counter to fill a medication dispenser with medicine stored in bottles.
2. Moving furniture (cooperative): When Person A was requested for help by Person B, (s)he went to the living room to assist Person B with moving furniture. The participant returned to the medication dispenser task after helping Person B.
3. Watering plants (individual): The participant watered plans in the living room using the watering can located in the hallway closet.
4. Playing checkers (cooperative): The participant brought a checkers game to the dining table and played the game with Person B.
5. Preparing dinner (individual): The participant set out ingredients for dinner on the kitchen counter using the ingredients located in the kitchen cupboard.
6. Reading magazine (individual): The participant read a magazine while sitting in the living room. When Person B asked for help, Person A went to Person B to help locate and dial a phone number. After helping Person B, Person A returned to the living room and continued reading.
7. Gathering and packing picnic food (individual): The participant gathered five appropriate items from the kitchen cupboard and packed them in a picnic basket. (S)he helped Person B to find dishes when asked for help. After the packing was done, the participant brought the picnic basket to the front door.

Person B:
1. Hanging up clothes (individual): The participant hung up clothes that were laid out on the living room couch, using the closet located in the hallway.
2. Moving furniture (cooperative): The participant moved the couch to the other side of the living room. (S)he requested help from Person A in moving the couch. The person then (without or without the help of Person A) moved the coffee table to the other side of the living room as well.
3. Reading magazine (individual): The participant sat on the couch and read the magazine located on the coffee table.
4. Sweeping floor (individual): The participant fetched the broom and the dust pan from the kitchen closet and used them to sweep the kitchen floor.
5. Playing checkers (cooperative): The participant joined Person A in playing checkers at the dining room table.
6. Setting the table (individual): The participant set the dining room table using dishes located in the kitchen cabinet.
7. Paying bills (cooperative): The participant retrieved a check, pen, and envelope from the cabinet under the television. (S)he then tried to look up a number for a utility company in the phone book but later asked Person A for help in finding and dialing the number. After being helped, the participant listened to the recording to find out a bill balance and address for the company. (S)he filled out a check to pay the bill, put the check in the envelope, addressed the envelope accordingly and placed it in the outgoing mail slot.
8. Gathering and packing picnic supplies (cooperative): The participant retrieved a Frisbee and picnic basket from the hallway closet and dishes from the kitchen cabinet and then packed the picnic basket with these items. The participant requested help from Person A to locate the dishes to pack.

The average activity time and number of sensor events generated for each activity are shown in the table below:

| | Person A | Person A | Person B | Person B |
|---|---|---|---|---|
| Activity | time | #events | time | #events |
| 1 | 3.0 | 47 | 1.5 | 55 |
| 2 | 0.7 | 33 | 0.5 | 23 |
| 3 | 2.5 | 61 | 1.0 | 18 |
| 4 | 3.5 | 38 | 2.0 | 72 |
| 5 | 1.5 | 41 | 2.0 | 25 |
| 6 | 4.5 | 64 | 1.0 | 32 |
| 7 | 1.5 | 37 | 5.0 | 65 |
| 8 | N/A | N/A | 3.0 | 38 |

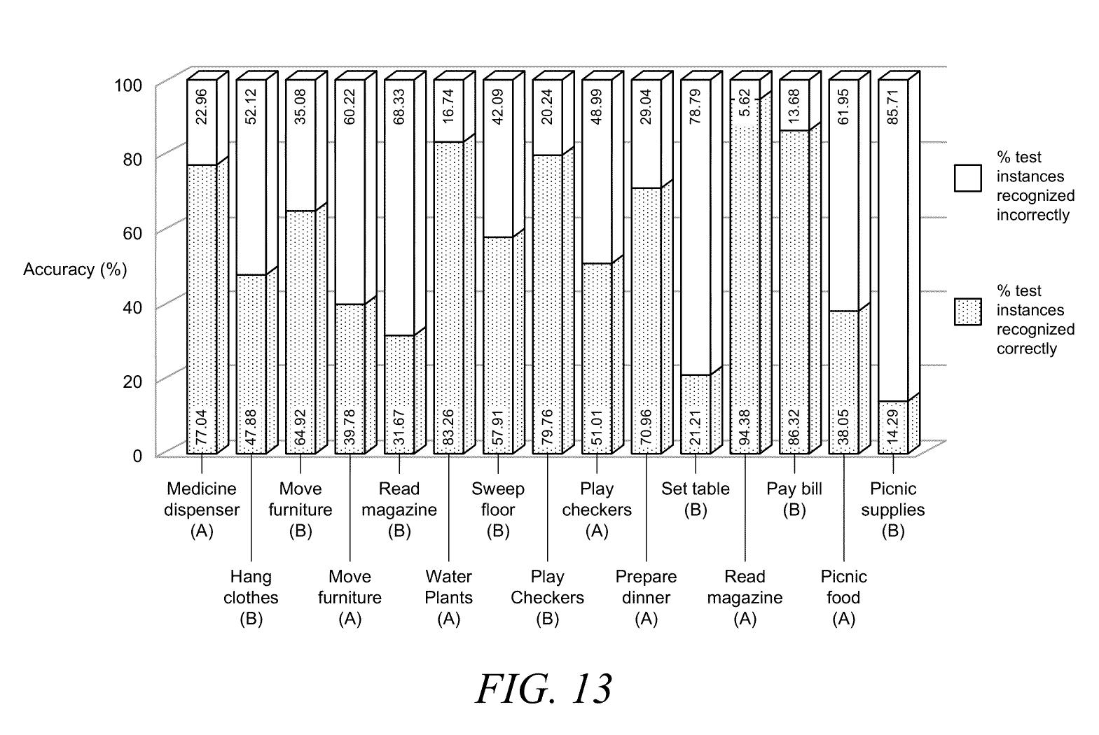

Initially, all of the sensor data for the 15 activities were included in one dataset and the labeling accuracy of the HMM was evaluated using 3-fold cross validation. The HMM recognized both the person and the activity with an average accuracy of 60.60%, higher than the expected random-guess accuracy of 7.00%. FIG. 13 shows the accuracy of the HMM by activity. As shown in FIG. 13, those activities that took more time and generated more sensor events (e.g., Read magazine A, 94.38% accuracy) tend to be recognized with greater accuracy. The activities that are very quick (e.g., Set table B, 21.21% accuracy) did not generate enough sensor events to be distinguished from other activities and thus yielded lower recognition results.

Separating Models for Residents

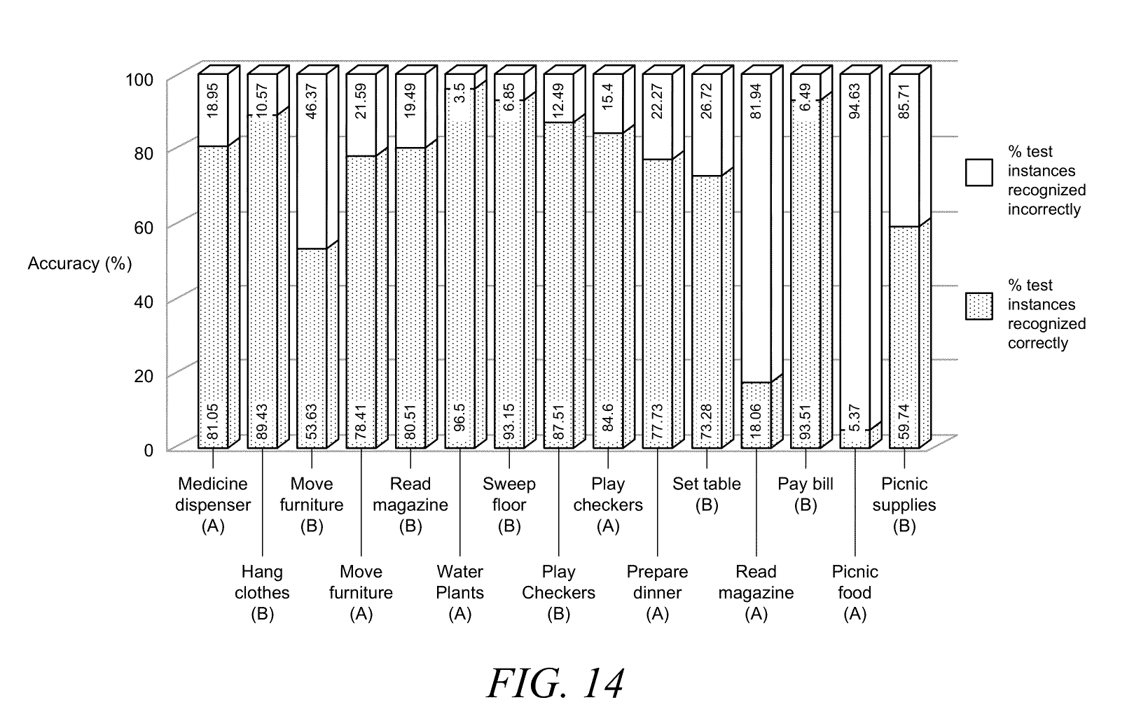

Instead of having one HMM representing multiple residents, one HMM was generated for each of the residents in further experiments. Each of the models contains one hidden node for each activity and observable nodes for the sensor values. The sensor data were collected from the combined multiple-resident apartment where the residents were performing activities in parallel. The average accuracy of the new model is 73.15%, as shown in FIG. 14.

### Illustrative Smart Environment

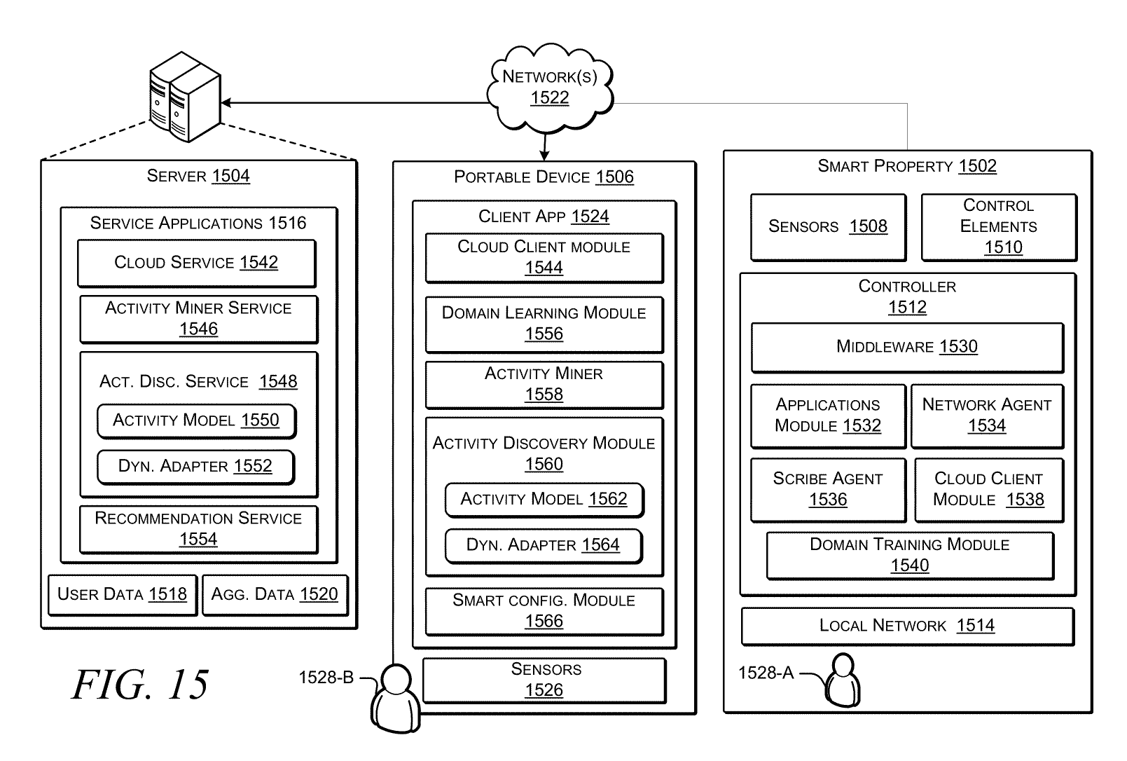

FIG. 15 is a schematic diagram of an automation system suitable for use in a smart environment 1500 in accordance with embodiments of the technology. As shown in FIG. 15, the smart environment 1500 may include a smart property 1502 such as the three bedroom apartment described in FIG. 1, one or more servers 1504 such as server 114, and a portable device 1506. In the illustrated example, the smart property 1502 includes a plurality of sensors 1508 such as sensors 111, a plurality of control elements 1510 such as control elements 112, a controller 1512 such as controller 113, and a local network 1514 such as local network 116. The controller 1512 may be operatively coupled to the sensors 1508, the control elements 1510, and/or the portable device 1506 via the local network 1514. In the illustrated example, the server 1504 includes service applications 1516, user data 1518, and aggregate data 1520. The server 1504 may be operatively coupled to the controller 1512 and/or the portable device 1506 via communication network(s) 1522 such as communication network 115. Further, the portable device 1506 includes a client app 1524 and one or more sensors 1526. In practice, the smart environment 1500 may include more than one of the smart property 1502, server 1504, and portable device 1506. Alternatively, the smart environment 1500 may be configured without one or more of the server 1504 and the portable device 1506.

In the illustrated example, the sensors 1508 may generate sensor data reflecting a state of the smart property 1502 and/or one or more residents 1528, such as residents 1528-A and 1528-B, of the smart property 1502. The sensors 1508 may include a motion sensor (e.g., ultraviolet light sensors, laser sensors, etc.), a positional sensor (e.g., a position switch on a door, a cabinet, or a refrigerator), an item sensor (e.g., a capacitive sensor for detecting a touch by a user), a temperature sensor, a water flow sensor, a vibration sensor, an accelerometer, a magnetic door sensor, a magnetic window sensor, a shake sensor, a gyroscope, a global positioning system (“GPS”) and/or other suitable types of sensors. In some examples, the sensors 1508 may communicate the sensor data to the controller 1512 via the local network 1514 in response to sensor readings made by the sensors 1508. Alternatively, the sensors 1508 may communicate the sensor data to the controller 1512 via the communication network 1522.

The local network 1514 may include one or more types of networks, including wired and/or wireless technologies (e.g., Wireless USB, Radio Frequency (RF), cellular, satellite, Bluetooth, WiFi, Wireless Personal Area Network (WPan), etc.). In some examples, the local network 1514 may be a wireless mesh network (e.g., ZigBee® network) or other type of wireless ad hoc network. The communication network(s) 1522 may include a local area network (LAN), a wide area network (WAN), such as the Internet, or any combination thereof, and may include both wired and wireless communication technologies, including cellular communication technologies.

In some implementations, the controller 1512 may contain middleware 1530 configured to manage the components of the smart property 1502 and information flow between the various software and hardware components of the smart property 1502. Middleware 1530 can represent a hardware component configured as middleware to route sensor data messages. Middleware 1530 can also represent a software module that upon execution configures a computer component to route sensor data messages. For example, the middleware 1530 may route sensor data messages to software and hardware components within the smart property 1502. In some examples, the middleware 1530 may send the sensor data messages to an applications module 1532 of the controller 1512.

The applications module 1532 of the controller 1512 may recognize activities of the resident in the smart property 1502. Further, the applications module 1532 may select operations of the one or more control elements 1510 for automation based on the recognized activities (e.g., by turning on a light, opening a door, etc.). For example, the applications module 1532 may send a message to the middleware 1530 containing automation instructions for one or more of the control elements 1510. The middleware 1530 may then forward the message to one or more of the control elements 1510, and the control elements 1510 may execute the instructions. In some examples, the middleware 1530 may determine to send a message including automation instructions to the control element 1510 based on a location and/or a functionality of the control element 1510.

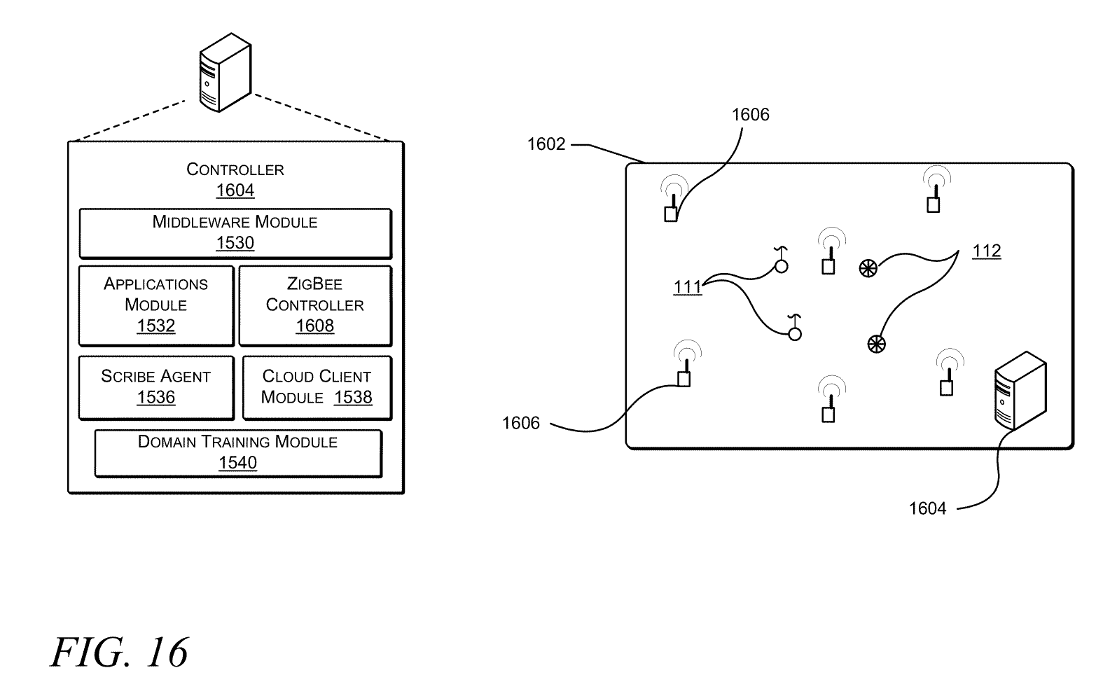

Further, the controller 1512 may include a network agent 1534 configured to manage the local network 1514. The network agent 1534 may maintain a model of the devices admitted to the local network 1514, including each sensor 1508 and control element 1510 on the local network 1514. In some examples, the local network 1514 may be a ZigBee® wireless mesh network as described herein with respect to FIG. 16. Further, the network agent 1534 may be a ZigBee® controller as shown in FIG. 16.

As shown in FIG. 15, the controller 1512 may further include a scribe agent 1536 that logs messages communicated by the software and hardware components of the smart property 1502. The controller 1512 may further include a cloud client module 1538 configured to transmit smart property 1502 data to the server 1504 for further processing and archiving. The smart property 1502 data may include data archived by the scribe agent 1536, sensor data associated with the sensors 1508, instruction data associated with the control elements 112, activities of the residents 1528, messages communicated amongst the components of the smart property 1502, configuration and settings of the components of the smart property 1502, load and performance data related to the components of the smart property 1502, and application data associated with the applications module 1532 (e.g., activities recognized by the applications module 1532). In some examples, the cloud client module 1538 may be configured to send the smart property 1502 data to the server 1504 periodically or in accordance with a predetermined schedule.

Alternatively, the cloud client module 1538 may dynamically determine to send smart property 1502 data to the server 1504 based on resource optimization techniques. For example, the cloud client module 1538 may utilize a scheduling algorithm based in part on a capacity of communication network 1522, an expected processing load of one or more of the components of the smart property 1502, expected activity of the residents 1528, and/or the size of the smart property 1502 data being sent to the server 1504.

In the illustrated example, the controller 1512 includes a domain training module 1540. The domain training module 1540 facilitates the collection of resident 1528 data by the portable device 1506 in environments outside of the smart property 1502. The domain training module 1540 may teach the portable device 1506 a model of activities that occur within the smart property 1502. Further, the domain training module 1540 may map and/or translate between the smart property 1502 activity model and the activity model of the portable device 1506 based on information received from the portable device 1506.

As shown in FIG. 15, the server 1504 may include a plurality of service applications 1516. The service applications 1516 may include a cloud service 1542 that communicates with the cloud client module 1538 of the controller 1512 and/or a cloud client module 1544 of the portable device 1506. The cloud service 1542 may receive data associated with the smart property 1502 and/or the one or more residents 1528 from the cloud client module 1538 and/or the cloud client module 1544. The cloud service 1542 may store the data as user data 1518. In some examples, the server 1504 logically groups the contents of the user data 1518 by smart property and/or resident 1528. Further, the cloud service 1542 may encrypt the data prior to storing the data as user data 1518. In addition, based upon configuration settings selected by one or more of the residents 1528, the cloud service 1542 may store the data in aggregate data 1520 along with data associated with additional smart properties and the residents of the additional smart properties. In some examples, the cloud service 1542 may anonymize the data prior to storing the data as aggregate data 1520.

Further, the cloud service 1542 may provide software updates to the client app 1524 of the portable device 1506 and the components of the controller 1512. For example, the cloud service 1542 may provide the controller 1512 with an updated version of the middleware 1530 that includes additional features. Further, the cloud service 1542 may transfer archived data stored in the user data 1518 to the controller 1512 as a part of a data recovery process. In some examples, the resident 1528 may transfer archived data to one or more controllers outside of the smart property 1502. For instance, one or more residents 1528 may move from the smart property 1502 to a new residence and transfer the archived data to a controller within the new residence. As a result, a controller within the new residence would be able to automate activities in the new residence based upon activities and patterns learned in the smart property 1502.

The service applications 1516 may further include an activity miner 1546, an activity discovery service 1548 that may include an activity model 1550 and a dynamic adapter 1552, and a recommender service 1554. The activity miner service 1532, the activity model 1550, and the dynamic adapter 1552 may have the same or similar functionality as counterparts found in the controller 113 as described herein. Further, the activity miner service 1532 and the activity discovery service 1548 may collect information from the user data 1518 and/or aggregate data 1520, thus providing distributed processing and the detection of system wide trends via crowdsourced data collection. In addition, the cloud service 1542 may send activities and patterns recognized by the activity miner service 1532 and the activity discovery service 1548 to the portable device 1506 and the controller 1512.

In addition, the recommender service 1554 may also process the user data 1518 and/or aggregate data 1520. The recommender service 1554 may identify modifications that can be made to the configuration and settings of the components of the smart property 1502. For example, the recommender service 1554 may determine an optimal sensitivity setting for a sensor 1508. Further, the recommender service 1554 may use the cloud service 1542 to communicate recommendations to the portable device 1506 and/or the controller 1512.

As shown in FIG. 15, the portable device 1506 may include the client app 1524 and sensors 1526. The portable device 1506 may be a smart phone, a smart watch, a fitness tracker device, wearable device, a personal digital assistant, a tablet, or a laptop computer. In some examples, the portable device 1506 may be a component of a larger mobile system such as a car or bicycle.

The sensors 1526 may include a wearable sensor, a motion sensor (e.g., ultraviolet light sensors, laser sensors, etc.), an item sensor (e.g., a capacitive sensor for detecting a touch by a user), a temperature sensor, a water flow sensor, a vibration sensor, an accelerometer, a shake sensor, a gyroscope, a global positioning system sensor (“GPS”) and/or other suitable types of sensors. The sensors 1526 may generate sensor data reflecting a state of a physical environment occupied by a resident 1528-B and/or a state of the resident 1528-B in possession of the portable device 1506. The sensors 1526 may communicate the sensor data to the client app 1524 of the portable device 1506. Further, the client app 1524 may provide the collected sensor data to the controller 1512.

In the illustrated example, the client app 1524 further includes a domain learning module 1556, an activity miner 1558, an activity discovery module 1560 that may include an activity model 1562 and a dynamic adapter 1564, the cloud client module 1544, and a smart configuration service 1566. The domain learning module 1556 ensures that the components of the smart property 1502 are informed of activities performed by the resident 1528-B in possession of the portable device 1506, while the resident 1528-B occupies environments outside of the smart property 1502. The domain learning module 1556 may learn an activity model of the controller 1512 from the domain training module 1540. The learned model of activities may then be used by the activity miner 1558 and the activity discovery module 1560 to identify activities and patterns of the resident 1528-B while the resident 1528-B is outside of the smart property 1502.

The activity miner 1558, the activity model 1562, and the dynamic adapter 1564 may have the same or similar functionality as counterparts found in the controller 113 and further described herein. Further, the cloud client module 1544 may have the same or similar functionality as the cloud client module 1538 found in the controller 1512 and further described herein.

Further, the client app 1524 may include a smart configuration module 1566. The smart configuration service 1566 may register sensors 1508 and/or control elements 1510 installed within the smart property 1502 with the controller 1512. The smart configuration module 1566 provides an efficient and user-friendly process for adding sensors 1508 and/or control elements 1510 to the smart environment 10.

ZigBee® Mesh network

FIG. 16 illustrates a ZigBee® local wireless mesh network 1602, according to an example embodiment, to facilitate communications within the smart property 1502. ZigBee® is an ad hoc wireless communication technique that is suitable for a local smart home network. ZigBee® wireless mesh networks provide multiple communication paths between a sender and receiver, and a robust device pairing process for scalable network admission. The local wireless mesh network 1602 may perform at least the functions of the local network 1514 as described herein.

As shown in FIG. 16, the local wireless mesh network 1602 operatively connects a controller 1604, one or more sensors 1508, one or more control elements 1510, and one or more ZigBee® intermediary devices 1606. Only some of the ZigBee® intermediary devices are shown with the reference number 1606 for ease of illustration. The controller 1604 may perform at least the functions of the controller 113 and the controller 1512 as described herein. Further, the controller 1604 may include a ZigBee® controller 1608. The ZigBee® controller 1608 may perform at least the functions of the network agent 1534 as described herein. Further, the ZigBee® controller 1608 establishes and administers the local wireless mesh network 1602. Once the ZigBee® controller 1608 establishes the local wireless mesh network 1602, the sensors 1508 and/or control elements 1510 may communicate with the controller 113 via the local wireless mesh network 1602. In some examples, the ZigBee® controller 1608 may be a software based network controller to manage the sensors 1508, the control elements 1510, and ZigBee® intermediary devices 1606.

Further, the sensors 1508 and control elements 1510 may possess ZigBee® radio capabilities, and thus be capable of providing communication paths within the local wireless mesh network 1602. In some examples, the local wireless mesh network 1602 may further include one or more ZigBee® intermediary devices 1606 for transmitting messages to devices connected to the local wireless mesh network 1602.

### Controller Device

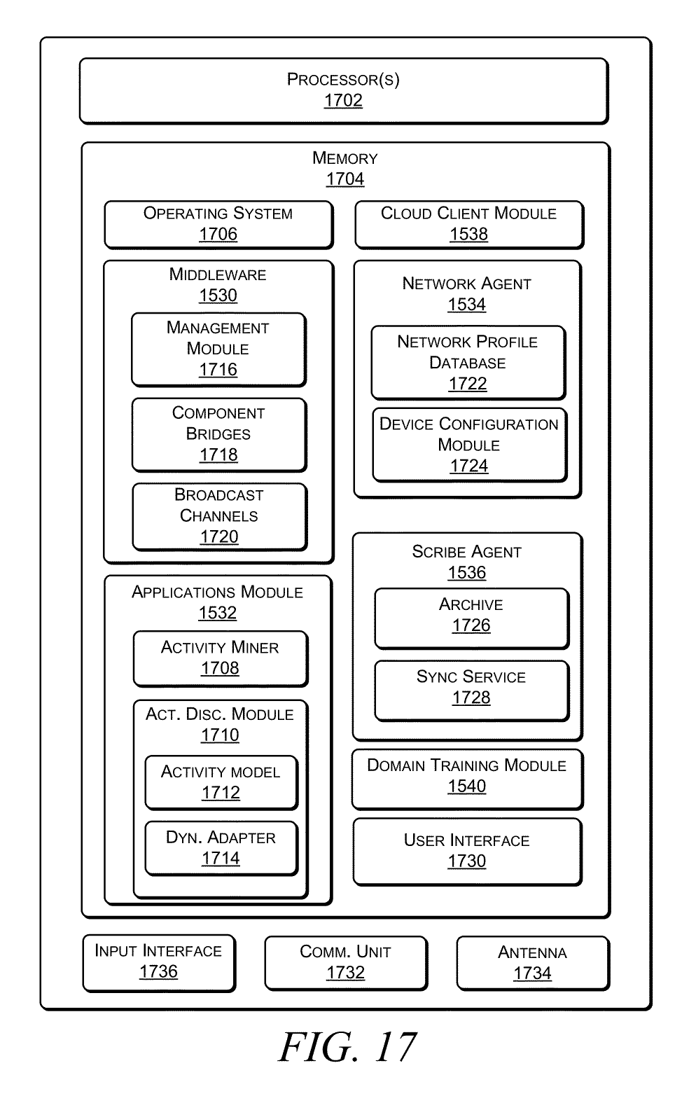

FIG. 17 shows select components of a controller, for example the controller 1512. Although, in other examples the controller could represent the controller 113 and/or the controller 1604. that the illustrated controller may be used to implement the techniques and functions described herein according to some implementations. The controller 1512 may be implemented by one or more computers having processing, memory, and communications capabilities. The controller 1512 may be a dedicated device, or a general computer system programmed to recognize activities of a resident 1528 in the smart environment 10, and automate the operations of the control elements 1510 based on the recognized activities (e.g., by turning on a light, opening a door, etc.).

As shown in FIG. 17, the controller 1512 includes one or more processors 1702 and computer-readable media 1704. The processor(s) 1702 can be configured to fetch and execute computer-readable instructions stored in the computer-readable media 1704 or other computer-readable media.

Computer-readable media as described herein includes computer-readable storage media comprising volatile and nonvolatile memory and/or removable and non-removable media implemented in any type of technology for storage of information, such as computer-readable instructions, data structures, program modules or other data. Such computer-readable storage media includes, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, or any other medium that can be used to store the desired information and that can be accessed by a computing device. Depending on the configuration of an implementation, the computer-readable media may be a type of computer-readable media that includes transitory propagating signals or a type of computer-readable storage media that is a tangible non-transitory storage media. Computer-readable storage media as described herein does not include computer-readable media solely made up of transitory propagating signals per se.

Several modules, such as instructions, datastores, and so forth may be stored within the computer-readable media 1704 and configured to execute on a processor(s) 1702. An operating system 1706 is configured to manage hardware and services within and coupled to the controller 1512 for the benefit of other components. An applications module 1532 which includes one or more applications for recognizing activities of a resident in the smart environment 10, and automating the operations of the control elements 1510 based on the recognized activities. For instance, the applications module may include an activity miner such as activity miner 104, and an activity discovery module 1710 including an activity model 1712 such as the activity model 108 and a dynamic adapter 1714 such as the dynamic adapter 106. Further, middleware 1530 is configured to provide services and information flow between the various software and hardware components of the smart environment 10. The middleware 1532 may include a management module 1708, one or more component bridges 1710, and one or more broadcast channels 1712.

The controller 1512 further includes the network agent module 1534 that may be configured to manage the local network 1514. The network agent module 1534 may maintain a model of the devices admitted to the local network 1514, including each sensor 1508 and control element 1510 on the local network 1514. In one embodiment, the network agent module 1534 may include a network profile database 1714 that stores a device name, device identifier (e.g., Media Access Control (MAC) address, serial number, etc.), device status, current device settings, and available device settings for each device on the local network 1514. In some examples, the network profile database 1714 may be a SQL database (e.g., SQLite®, MySQL®, MS-SQL®, PostGres®, etc) and/or No-SQL database (e.g., MongoDB®, Redis®, Cassandra®, etc). Moreover, embodiments support tables of various data structures, including but not limited to relational databases, hierarchical databases, networked databases, hash tables, linked lists, flat files, and/or unstructured data. Further, the network agent module 1534 may update the network profile database 1714 as devices join, leave, and operate on the local network 1514. In addition, the network agent module 1534 may monitor communications among the devices connected to the local network 1514, and associate sequence numbers with the communications of each device on the local network 1514.

Further, the network agent module 1534 may include a device configuration module 1716 configured to provide remote administration of devices admitted to the local network 1514. In some embodiments, the device configuration module 1716 may receive commands and/or instructions to modify the current device settings of a device connected to the local network 1514. For example, resident 1528 operating remotely may transmit a command to the device configuration module 1716 modifying the sensitivity of one or more the sensors 1508 on the local network 1514.

The controller 1512 further includes a scribe agent 1536 configured to archive messages sent to and from the controller 1512 in an archive 1718. The archive 1718 may be a permanent storage location. In some examples, the archive may be SQL database (e.g., SQLite®, MySQL®, MS-SQL®, PostGres®, etc.) and/or No-SQL database (e.g., MongoDB®, Redis®, Cassandra®, etc.). Moreover, embodiments support tables of various data structures, including but not limited to relational databases, hierarchical databases, networked databases, hash tables, linked lists, flat files, and/or unstructured data. In some examples, the scribe agent 1536 may periodically compress the contents of the archive 1718 to preserve storage space.

Further, the scribe agent 1536 may include a sync client 1720 configured to upload the current version of a message log to the server 1504 via the cloud client module 1538.

The controller 1512 may further be equipped with the user interface 110. The user interface 110 may include a touchscreen and various user controls (e.g., buttons, a joystick, a keyboard, a mouse, etc.), speakers, a microphone, a camera, connection ports, and so forth. For example, the operating system 1706 of the controller 1512 may include suitable drivers configured to accept input from a keypad, keyboard, or other user controls and devices included as the user interface 1730. For instance, the user controls may include page turning buttons, navigational keys, a power on/off button, selection keys, and so on. Additionally, the controller 1512 may include various other components that are not shown, examples of which include removable storage, a power source, such as a battery and power control unit, a PC Card component, and so forth.

The controller 1512 further includes a communication unit 1722 to communicate with the controller 1512 or with other computing devices. The communication unit 1722 enables access to one or more types of network, including wired and wireless networks. More generally, the coupling between the controller 1512 and any components in the smart environment 10 may be via wired technologies, wireless technologies (e.g., RF, cellular, satellite, Bluetooth, etc.), or other connection technologies. When implemented as a wireless unit, the communication unit 1722 uses an antenna 1724 to send and receive wireless signals.

The controller 1512 may further include an input interface 1736 operatively coupled to the middleware 1530 and/or communication unit 1722. In certain embodiments, the input interface 1736 may include an analog input module, a discrete input module, and/or other suitable hardware components for receiving sensor data. In other embodiments, the input interface 1736 may include an Ethernet driver, a USB driver, and/or other suitable software components. In further embodiments, the input interface 1736 may include both hardware and software components.

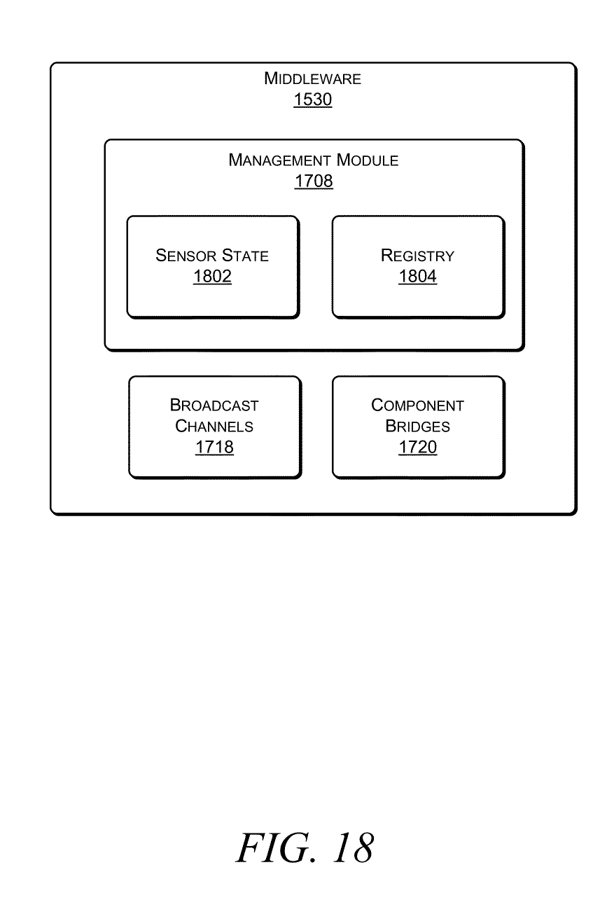

FIG. 18 shows select components of the middleware 1530 that may be used to implement the techniques and functions described herein according to some implementations. The middleware 1530 provides services and information flow between the various applications and hardware components comprising the smart environment 10.

As shown in FIG. 18, the middleware 1530 includes a management module 1708, one or more component bridges 1710, and one or more broadcast channels 1712. The management module 1708 is configured to govern the middleware 1530. In some examples, the management module 1708 may be a publisher/subscriber manager (i.e., publisher/subscribe broker).

The management module 1708 may process messages generated within the smart environment 10. For example, the management module 1708 may receive a message generated by a sensor 1508 and assign a time stamp and/or a universally recognizable identifier to the message. The management module 1708 may then provide the message to subscribers of the sensor 1508 that published the event message.

The management module 1708 may further include a sensor state module 1802 and a registry module 1804. The sensor state module 1802 may be configured to maintain the state of each sensor 1508 within the smart environment 10. Further, the management module 1708 may receive one or more messages associated with the status of a sensor 1508 and modify a representation of the status of the sensor 1508 in the sensor state module 1802.

Further, the middleware 1530 may include one or more broadcast channels 1712 configured to transmit messages between the components of the smart environment 10. For example, the raw event broadcast channel 1710 may transmit messages generated by one or more of the sensors 1508 to the middleware 1530.

In addition, the management module 1708 may include one or more component bridges 1710. The middleware 1530 may establish and configure the one or more component bridges 1710 to support communication between the components of the smart environment 10 and the management module 1708. The component bridges 1710 may connect the broadcast channels 1712 to their endpoints, manage the connections details of broadcast channels 1712, and perform message translation on messages communicated via the broadcast channels 1712.

In some examples, the component bridges 1710 may be customized Extensible Messaging and Presence Protocol (XMPP) bridges. For example, the management module 1708 may establish a scribe bridge 1710 for communication between the scribe agent 1536 and the management module 1708. Further, the management module 1708 may establish a network agent bridge 1710 for communication between the network agent 1534 and the management module 1708. In some examples, the network agent bridge 1710 may be a ZigBee® bridge for communications between a ZigBee® controller 1604 and the management module 1708.

The registry module 1804 may be configured to store an identifier of each component within the smart environment 10, a value identifying whether the component is a publisher and/or subscriber, a value identifying a location of the component, one or more values identifying the subscriptions of the component, and one or more channels that may be used to send and/or receive messages to and from the component. For example, an entry in the registry module 1804 may contain an identifier of a sensor 1508 (e.g., psensor_{—}1234), an indication that the sensor 1508 is a publisher, an identifier of the broadcast channel 1710 (e.g., raw event channel) the sensor 1508 may use to communicate sensor messages to the management module 1708, and a representation of the one or more applications 1532 that are subscribers to the sensor 1508. Further, the management module 1708 may receive a message from the sensor 1508 and determine the subscriber components of the sensor 1508 based on the smart environment 10 components that are recorded as subscribers to the sensor 1508 within the registry module 1804.

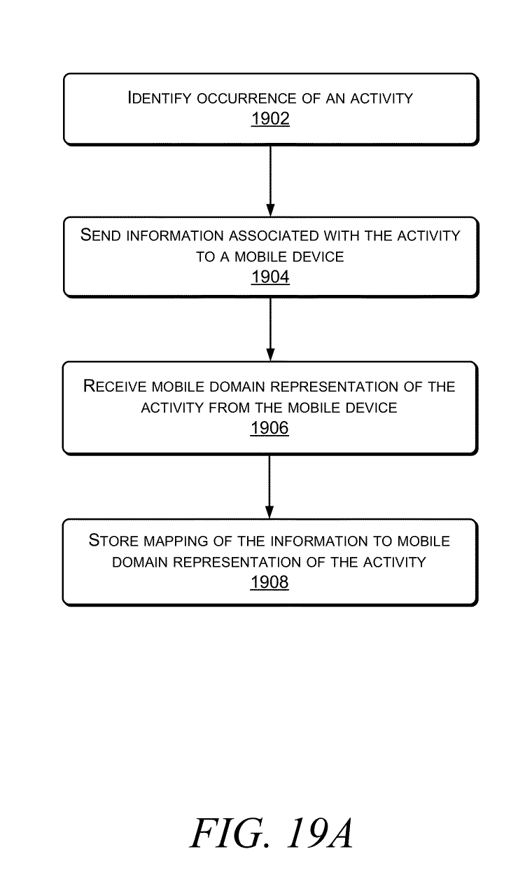

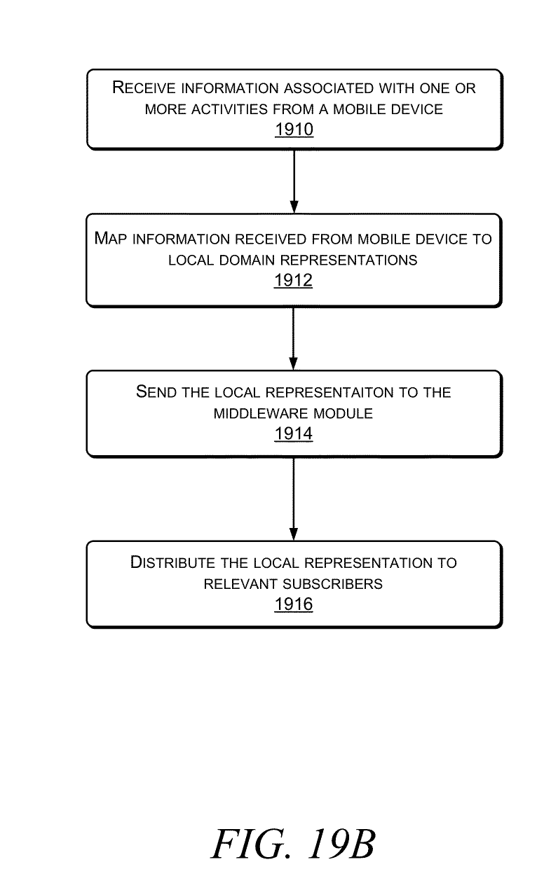

FIG. 19A shows the cross domain transfer process 1900 that may be implemented by the smart environment 10. The process is illustrated as a collection of blocks in a logical flow graph. Some of the blocks represent actions taken by the controller 1512. In the context of software-based operations, the blocks represent computer-executable instructions stored on the computer-readable media 1704 that, when executed by one or more processors 1702, direct the controller 1512 to perform the recited acts. The order in which the operations are described is not intended to be construed as a limitation, and any number of the described blocks can be combined in any order or in parallel to implement the processes. In some examples, the following process may be automatically triggered based upon the presence of the portable device on the local network 1514. Alternatively, the process may be manually instantiated based upon input to the portable device 1506 and/or the user interface 110 of the controller 1512.

At 1902, the controller 1512 identifies the occurrence of an activity. For example, at 6:00 pm the resident 1528-A may retrieve oatmeal, brown sugar, and raisins from the kitchen cabinet. Next, the resident 1528-A may cook the oatmeal on the stove, and add the sugar and raisins to the oatmeal while the oatmeal is cooking. Once the oatmeal is done cooking, the resident 1528-A may eat the oatmeal inside of the smart property 1502 while wearing a smart watch device 1510. Based upon sensor data received from the sensors 1508, the controller 1512 may identify that the resident 1528-A has prepared and consumed a meal.

At 1904, the domain training module 1540 sends information associated with the activity to the portable device 1506. In some examples, the data may include an activity label associated with the activity, the duration of the activity, the time of occurrence, and/or one or more residents 1528 that performed the activity. For example, the domain training module 1540 may transmit an activity label indicating that the resident 1528-A prepared and consumed a meal, and information indicating that the preparation and consumption of the meal took place for an hour starting at 6:00 pm to the smart watch device 1510.

At 1906, the domain training module 1540 receives a representation of the activity in the domain of the portable device 1506. For example, the portable device 1506 may send a message to the domain training module 1540 including sensor readings from the sensors 1526 of the smart watch device 1510 that were collected during a time period including the hour that the resident 1528-A prepared and consumed the meal. Alternatively, the controller 1512 may receive a feature vector representation from the smart watch device 1510.

At 1908, the domain training module 1540 stores a mapping of the information to the mobile domain representation of the activity. For example, the domain training module 1540 may generate a mapping between the activity label associated with preparing and eating a meal within the activity model to the sensor readings received from the sensors 1526 of the smart watch device 1510. In some examples, the domain training module 1540 may further receive information from the cloud service 1542 of the server 1504 to assist in the mapping between the domain of portable device 1506 and the domain of the controller 1512.

FIG. 19B shows the cross domain reporting process 1900 that may be implemented by the smart environment 10. The process is illustrated as a collection of blocks in a logical flow graph. Some of the blocks represent actions taken by the controller 1512. In the context of software-based operations, the blocks represent computer-executable instructions stored on the computer-readable media 1704 that, when executed by one or more processors 1702, direct the controller 1512 to perform the recited acts. The order in which the operations are described is not intended to be construed as a limitation, and any number of the described blocks can be combined in any order or in parallel to implement the processes. It is understood that the following processes may be implemented with other architectures than the smart environment 10 described above. In some examples, the following process may be automatically triggered based upon the presence of the portable device 1506 on the local network 1514. Alternatively, the process may be manually instantiated based upon input to the portable device 1506 and/or the user interface 110 of the controller 1512.

At 1910, the domain training module 1540 receives information associated with one or more activities performed by the resident 1528 from the portable device 1506. For example, the resident 1528-A may prepare and eat a meal outside of the smart property while wearing a smart watch device 1510. Based upon a previously learned activity model, the smart watch device 1510 may send a message to the domain training module 1540 including an activity label indicating the resident prepared and consumed a meal. The message may further include sensor data associated with the resident's 1516-1 preparation and consumption of the meal such as the sensor readings of the sensors 1526 of the smart watch device 1510.

At 1912, the domain training module 1540 maps the information contained in the message received from the portable device 1506 to a representation within the activity model 108 of the controller 1512. For example, the domain training module 1540 may receive an activity label indicating the resident prepared and consumed a meal, and map the activity label to the local representations of preparing and eating a meal within the activity model 108 of the smart property.

At 1914, the domain training module 1540 sends the results of the mapping to the middleware 1530. For example, domain training module 1540 may send the local representations associated with preparing a meal and eating a meal within the activity model 108 of the smart property 1502 to the middleware 1530.

At 1916, the middleware sends the local representations to components of the smart environment 1502 that have subscribed to messages including data from the sensors 1508 and/or messages including data from the sensors 1526 of the portable device 1506. For example, the middleware 1530 may send a message including the local representations resulting from the mapping to the scribe agent 1536 for archiving in the archive 1718.

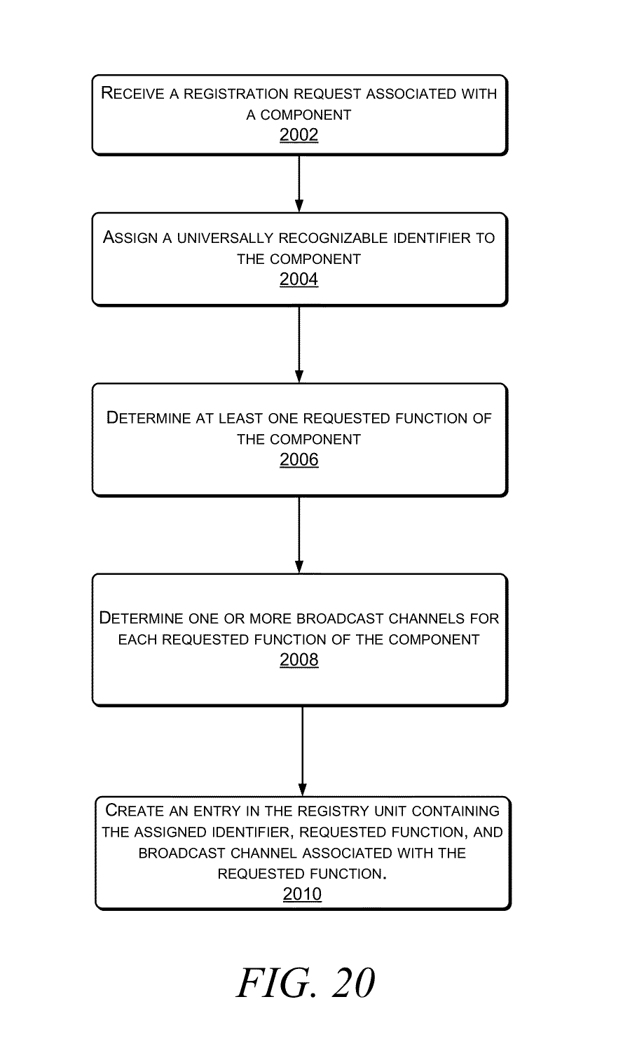

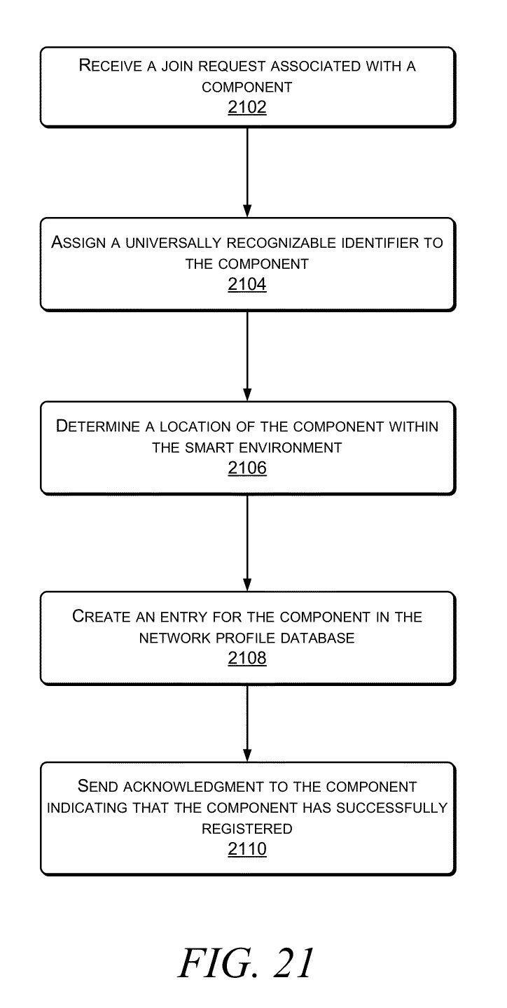

FIG. 20 shows the component registration process 2000 that may be implemented by the smart environment 10. The process is illustrated as a collection of blocks in a logical flow graph. Some of the blocks represent actions taken by the controller 1512. In the context of software-based operations, the blocks represent computer-executable instructions stored on the computer-readable media 1704 that, when executed by one or more processors 1702, direct the controller 1512 to perform the recited acts. The order in which the operations are described is not intended to be construed as a limitation, and any number of the described blocks can be combined in any order or in parallel to implement the processes. It is understood that the following processes may be implemented with other architectures than the smart environment 10 described above. In some examples, the following process may be automatically triggered based upon the presence of a new component on the local network 1514 and/or the installation of a new component on the controller 1512. Alternatively, the process may be manually instantiated based upon input to the user interface 110 of the controller 1512. Further, if the registering component will communicate with the smart environment 10 via the local network 1514, the registering component may also be required to initiate a join process at the network agent 1534 as illustrated in FIG. 21 and further described herein.

At 2002, the middleware 1530 receives a registration request associated with a component. For example, the middleware 1530 may receive a registration request associated with a positional sensor 1508 being installed in proximity to a window on the second floor of the smart property 1502.

At 2004, the middleware 1530 assigns a universally recognizable identifier to the component. In some examples, the registration message includes the identifier. Alternatively, the middleware 1530 may generate the identifier based at least in part on data associated with the component. For example, the registration request may include a universally recognizable identifier based at least in part on a serial number associated with the position sensor 1508 and/or a location of the position sensor 1508 within the smart property 1502 (e.g., psensor_x1234), and the middleware 1530 may assign the identifier to the position sensor 1508.

At 2006, the middleware 1530 determines at least one requested function (e.g., subscriber and/or publisher) of the component. For example, middleware 1530 may determine that the positional sensor 1508 is requesting to be registered as a publisher within the smart environment 10. In some embodiments, the registration request includes the at least one requested function.

At 2008, the middleware 1530 determines one or more broadcast channels 1712 for each requested function of the component. For example, the middleware 1530 may determine that the positional sensor 1508 is requesting to publish messages via the raw event broadcast channel 1710. In some embodiments, the registration request includes the broadcast channels 1712 associated with the requested functions of the component.

At 2010, the middleware 1530 creates an entry in the registry 1804 containing the assigned identifier, requested function, and broadcast channel associated with the requested function. For example, the middleware 1530 may store an entry including psensor_x1234, publisher, and raw event channel in the registry 1804. Further, in some examples, the entry may also include a location of the component. For instance, the entry may indicate that psensor_x1234 is located in proximity to a window on the second floor of the smart property 1502.

FIG. 21 shows the local network 1514 admittance process 2100 that may be implemented by the smart environment 10. The process is illustrated as a collection of blocks in a logical flow graph. Some of the blocks represent actions taken by the controller 1512. In the context of software-based operations, the blocks represent computer-executable instructions stored on the computer-readable media 1704 that, when executed by one or more processors 1702, direct the controller 1512 to perform the recited acts. The order in which the operations are described is not intended to be construed as a limitation, and any number of the described blocks can be combined in any order or in parallel to implement the processes. It is understood that the following processes may be implemented with other architectures than the smart environment 10 described above. In some examples, the following process may be automatically triggered based upon the presence of a new component on the local network 1514. Alternatively, the process may be manually instantiated based upon input to the user interface 110 of the controller 1512.

At 2102, the network agent 1534 receives a join request associated with a component. For example, a ZigBee® agent 1534 may receive a join request from a position sensor 1508 being installed in proximity to a window on the second floor of the smart property 1502.

At 2104, the network 1534 agent assigns a universally recognizable identifier to the component. For example, the ZigBee® agent 1534 may assign a universally recognizable identifier to the position sensor 1508 based at least in part on a serial number associated with the position sensor 1508 (e.g., psensor_x1234) provided in the join request. In some examples, the identifier may be included in the registration message. Alternatively, the middleware 1530 may generate the identifier based at least in part on data associated with component associated with the registration request.

At 2106, the network agent 1534 may determine the location of the component within the smart property 1502. For example, the ZigBee® agent 1534 may determine that the position sensor 1508 has been installed in proximity to a window on the second floor of the smart property 1502 from information included in the join message.

At 2008, the network agent may create an entry for the component in the network profile database 1714. For example, the ZigBee® agent 1534 may create an entry containing the identifier and location of the position sensor 1508.

At 2010, the network agent 1534 may send an acknowledgment to the component indicating that the component has successfully registered on the local network 1514. For example, the ZigBee® agent 1534 may send an acknowledgement to the position sensor 1508 indicating that the position sensor 1508 is admitted to the ZigBee® network 116.

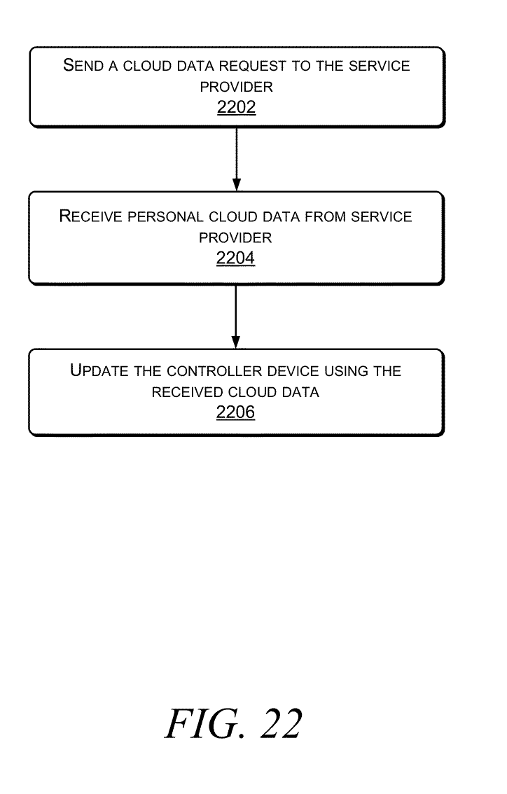

FIG. 22 shows the cloud data request process 2200 that may be implemented by the smart environment 10. The process is illustrated as a collection of blocks in a logical flow graph. Some of the blocks represent actions taken by the controller 1512. In the context of software-based operations, the blocks represent computer-executable instructions stored on the computer-readable media 1704 that, when executed by one or more processors 1702, direct the controller 1512 to perform the recited acts. The order in which the operations are described is not intended to be construed as a limitation, and any number of the described blocks can be combined in any order or in parallel to implement the processes. It is understood that the following processes may be implemented with other architectures than the smart environment 10 described above.

At 2202, the cloud client module 1538 may request cloud data from the server 1504. For example, the cloud client module 1538 of the controller 1512 may send a message to the server 1504 requesting update information. In some examples, the request may be initiated by the resident 1528 via the user interface 110. Alternatively, the cloud client module 1538 may automate the cloud data request. Further, in some examples, the cloud data may be used for data recovery and/or synchronizing a plurality of controllers 1512 located in separate smart properties.

At 2204, the cloud client module 1538 receives cloud data from the server 1504. For example, the cloud client module 1538 may receive an update to the activity model 108 from the server 1504.

At 2206, the cloud client module 1538 updates the controller 1512 using the received cloud data. For example, the cloud client module 1538 may update the activity model 108 using the update received from the server 1504.

### Example Portable Device

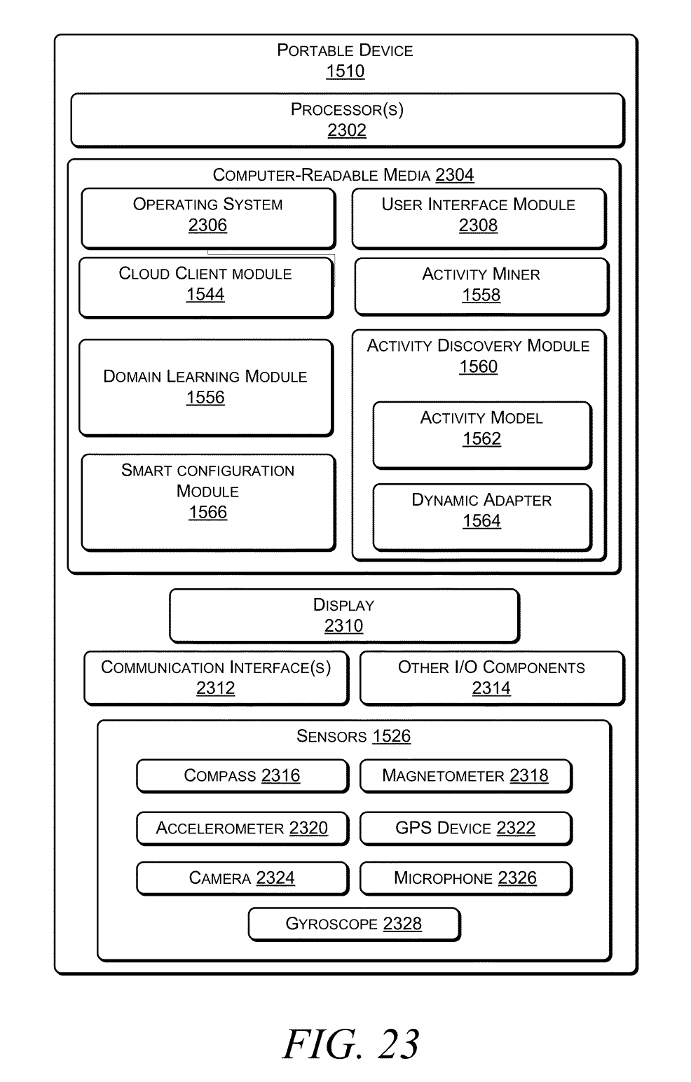

FIG. 23 illustrates select example components of the portable device 1506 that may be used to implement the functionality described above according to some implementations. In a very basic configuration, the portable device 1506 includes, or accesses, components such as at least one control logic circuit, central processing unit, or processor 2302 and one or more computer-readable media 2304. Each processor 2302 may itself comprise one or more processors or processing cores.

The computer-readable media 2304 may be used to store any number of functional components that are executable by the processor 2302, such as client app 1524. In some implementations, these functional components comprise instructions or programs that are executable by the processor 2302 and that, when executed, implement operational logic for performing the actions attributed above to the portable device 1506. Functional components of the portable device 1506 stored in the computer-readable media 2304 may be the client app 1524 that includes the domain learning module 1556, the activity miner 1558, the activity discovery module 1560, the activity model 1560, the dynamic adapter 1564, the cloud client module 1532, and the smart configuration module 1566, as described above, at least one of which may be executed by the processor 2302. Other functional components may include an operating system 2306 and user interface module 2308 for controlling and managing various functions of the portable device 1506. Depending on the type of the portable device 1506, the computer-readable media 2304 may also optionally include other functional components, which may include applications, programs, drivers and so forth.

The computer-readable media 2304 may also store data, data structures, and the like that are used by the functional components. For example, the portable device 1506 may also store data used by the domain learning module 1556, the activity miner 1558, the activity discovery module 1560, the activity model 1560, dynamic adapter 1564, the cloud client module 1532, the smart configuration module 1566, the operating system 2306, and the user interface module 2308. Further, the portable device 1506 may include many other logical, programmatic and physical components, of which those described are merely examples that are related to the discussion herein.

FIG. 23 further illustrates a display 2310, which may be passive, emissive or any other form of display. In some examples, the display 2310 may be an active display such as a liquid crystal display, plasma display, light emitting diode display, organic light emitting diode display, and so forth. In some examples, the display may be a touch-sensitive display configured with a touch sensor to sense a touch input received from an input effecter, such as a finger of a user, a stylus, or the like. Thus, the touch-sensitive display may receive one or more touch inputs, stylus inputs, selections of icons, selections of text, selections of interface components, and so forth.

One or more communication interfaces 2312 may support both wired and wireless connection to various networks, such as cellular networks, radio, WiFi networks, short-range or near-field networks (e.g., Bluetooth®), infrared signals, local area networks, wide area networks, the Internet, and so forth.

The portable device 1506 may further be equipped with various other input/output (I/O) components 2314. Such I/O components may include various user controls (e.g., buttons, a joystick, a keyboard, a mouse, etc.), speakers, connection ports, and so forth. For example, the operating system 2306 of the portable device 1506 may include suitable drivers configured to accept input from a keypad, keyboard, or other user controls and devices included as the I/O components 2314. For instance, the user controls may include page turning buttons, navigational keys, a power on/off button, selection keys, and so on. Additionally, the portable device 1506 may include various other components that are not shown, examples of which include removable storage, a power source, such as a battery and power control unit, a PC Card component, and so forth.

FIG. 23 further illustrates sensors that generate sensor data that is used by the functional components. As shown in FIG. 23, the one or more sensors 1526 may include a compass 2316, a magnetometer 2318, an accelerometer 2320, a GPS device 2322, a camera 2324, a microphone 2326, and a gyroscope 2328. For example, the accelerometer 2320 can be monitored in the background to check for motion that is indicative of certain types of activity or movement of the portable device 1506 and the resident 1528-B. Various different types of motion, such as gaits, cadence, rhythmic movements, and the like, can be detected by the accelerometer 2320 and may be indicative of prolonged presence within a specific location. The compass 2316 and gyroscope 2328 may further indicate motion based on a change in direction of the portable device 1506. The microphone 2326 may detect noises or sounds that may indicate particular locations or activities. In some cases, the camera 2324 may be used to detect a context, such as for determining a location of the portable device 1506, if permitted by the resident 1528-B. Additionally, communication interfaces 2312 can act as sensors to indicate a physical location of the portable device 1506, such as based on identification of a cell tower, a wireless access point, or the like, that is within range of the portable device 1506. Numerous other types of sensors 1526 may be used for determining a current activity of the portable device 1506 or resident 1528 associated with the portable device 1506, as will be apparent to those of skill in the art in light of the disclosure herein.

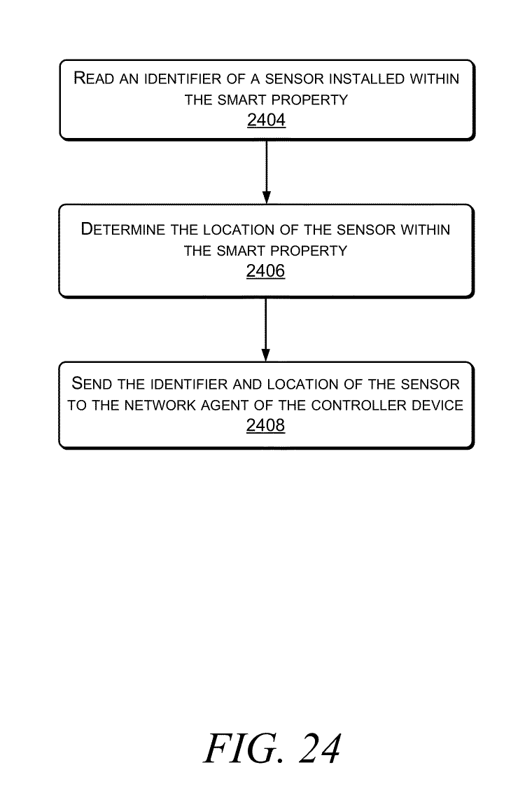

FIG. 24 shows the component registration process 2400 that may be implemented by the smart environment 10. The process is illustrated as a collection of blocks in a logical flow graph. Some of the blocks represent actions taken by the portable device 1506. In the context of software-based operations, the blocks represent computer-executable instructions stored on one or more computer-readable storage media 2304 that, when executed by one or more processors 2302, direct the portable device 1506 to perform the recited acts. The order in which the operations are described is not intended to be construed as a limitation, and any number of the described blocks can be combined in any order or in parallel to implement the processes. It is understood that the following processes may be implemented with other architectures than the smart environment 10 described above.

At 2402, the smart configuration module 1566 reads an identifier of a sensor 1508 installed within the smart property 1502. Each sensor 1508 may be identifiable by a universally recognizable identifier. The identifier may, for example, be implemented as a bar code, 2D/3D bar code, QR code, NFC tag, RFID tag, magnetic stripe, or some other scannable or readable mechanism, mark, or tag attached to or integrated with the sensor 1508. For example, the smart configuration module 1566 may read a QR code identifier of a position sensor 1508 being installed in proximity to a window on the second floor of the smart property 1502. In some examples, the QR code may be read by a sensor 1510 and/or input/output (I/O) component 2314 of the portable device 1506, and communicated to the smart configuration module 1566.

At 2404, the smart configuration module 1566 determines the location of the sensor 1508 within the smart property 1502. For example, the smart configuration module 1566 may request the resident 1528 enter the location of the position sensor 1508 (e.g., second floor window) via the user interface module 2306 of the portable device 1506. In some examples, the portable device may present a list of possible locations to the resident 1528, and the resident 1528 may select the location of the sensor 1508 from the list via the user interface 2306. Alternatively, the portable device 1506 may determine the location of the position sensor 1508 based at least in part on sensor readings of the sensors 1526 of the portable device 1506.

At 2406, the smart configuration module 1566 sends the identifier and location of the sensor 1508 to the network agent 1534 of the controller 1512. For example, the smart configuration module 1566 may send the QR code and/or a representation of the QR code, and location information describing the second floor window to the network agent 1534.

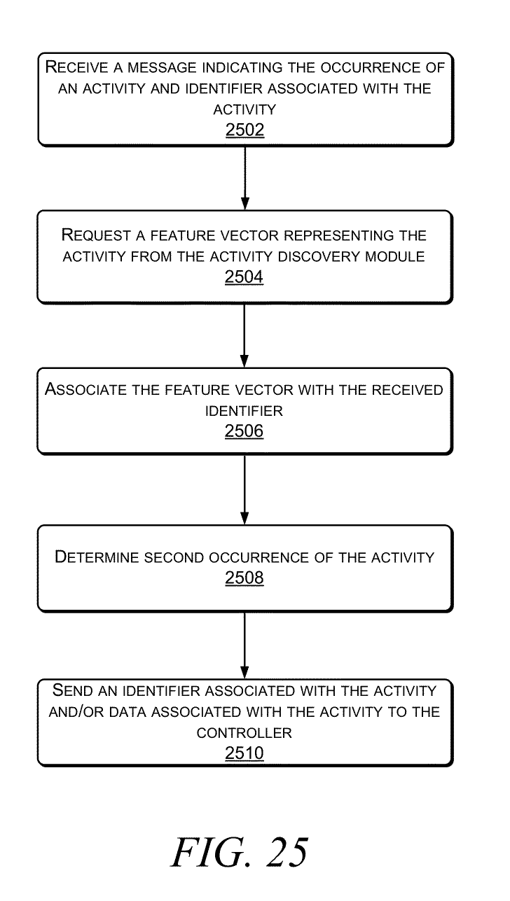

FIG. 25 shows the cross domain transfer process 2500 that may be implemented by the smart environment 10. The process is illustrated as a collection of blocks in a logical flow graph. Some of the blocks represent actions taken by the portable device. In the context of software-based operations, the blocks represent computer-executable instructions stored on one or more computer-readable storage media 2304 that, when executed by one or more processors 2302, direct the portable device 1506 to perform the recited acts. The order in which the operations are described is not intended to be construed as a limitation, and any number of the described blocks can be combined in any order or in parallel to implement the processes. It is understood that the following processes may be implemented with other architectures than the smart environment 10 described above.

At 2502, the portable device 1506 receives a message indicating the occurrence of an activity and an identifier associated with the activity. For example, the domain learning module 1556 of a smart watch device 1510 may receive a message containing an activity label indicating that the resident prepared and consumed a meal, and data indicating that the preparation and consumption of the meal took place for an hour starting at 6:00 pm.

At 2504, the portable device 1506 requests a feature vector representing the activity from activity discovery module 1560 of the portable device 1506. For example, the domain training module 1556 may request a feature vector from the activity discovery module 1560 based at least in part on the activity label indicating that the resident 1528 prepared and consumed a meal, and the data indicating that the activity was performed for an hour starting at 6:00 pm. In some examples, the feature vector may be based in part on sensor readings of the sensors 1526 of the portable device 1506 between 6:00 pm and 7:00 pm.

At 2506, the portable device 1506 associates the feature vector with data received from the controller 1512. For example, the domain learning module 1556 may receive a feature vector based at least in part on sensor readings of the sensors 1526 of the smart watch device 1510 between 6:00 pm and 7:00 pm, and store a mapping between the feature vector and the activity label received from the controller 1512.

At 2508, the portable device 1506 determines a second occurrence of the activity. For example, the resident 1528 may prepare and consume a meal outside of the smart property 1502 at a later date while wearing a smart watch device 1510. Further, the activity discovery module 1560 may recognize that the resident 1528 has prepared and consumed the meal.

At 2510, the domain learning module 1556 may send sensor data associated with the activity and/or the identifier associated with the activity to the controller 1512. For example, the domain learning module 1556 may send the activity label indicating that the resident 1528 prepared and consumed a meal to the controller 1512. In some examples, the smart watch device 1510 may detect that the resident 1528 is within the confines of the smart property 1502, and initiate the transmission of the sensor data associated with the activity and/or the identifier associated with the activity to the controller 1512 via local network 1514. Alternatively, the domain learning module 1556 may initiate the transmission to the controller 1512 from outside of the smart property 1502 via the communication network 1522.

Further, the domain learning module 1556 may be configured to send the sensor data associated with the activity and/or the identifier associated with the activity to the controller 1512 periodically or in accordance with a predetermined schedule. Alternatively, the domain learning module 1556 may dynamically determine to send the sensor data associated with the activity and/or the identifier associated with the activity to the controller 1512 based on resource optimization techniques. For example, the domain learning module 1556 may utilize a scheduling algorithm based in part on a capacity of communication network 1522 or local network 1514, an expected processing load of one or more of the components of the portable device 1506, an expected processing load of one or more of the components of the controller 1512, the battery life of the portable device 1506, and the expected activity of the residents 1528.

### Example Server

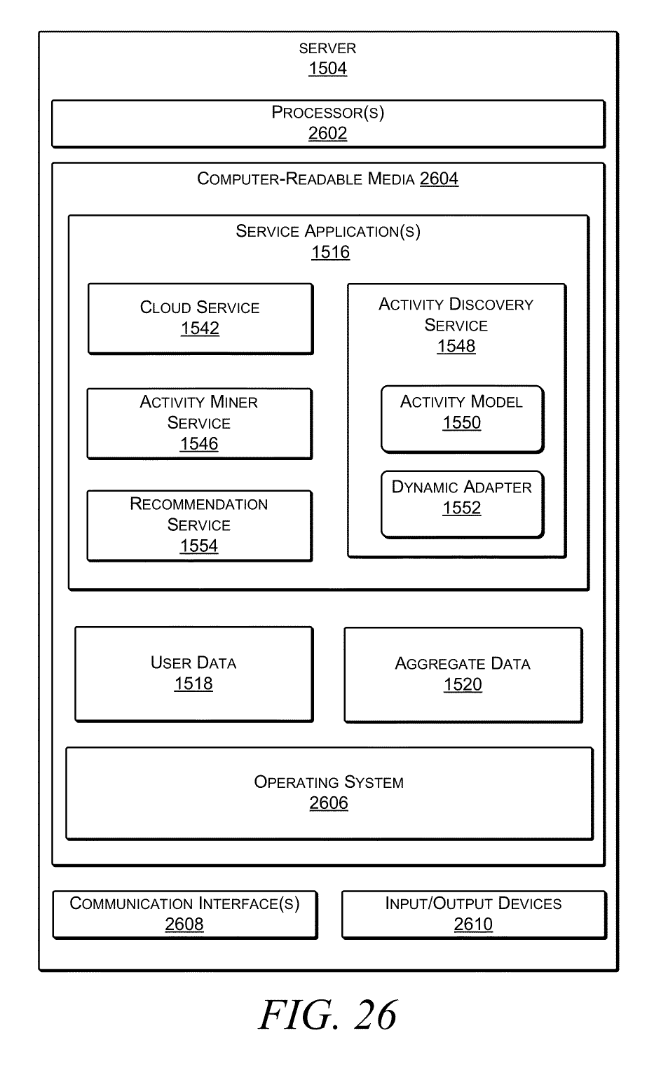

FIG. 26 illustrates select components of the server 1504 that may be used to implement the techniques and functions described herein according to some implementations. The server 1504 may be hosted on one or more servers or other types of computing devices that may be embodied in any number of ways. For instance, in the case of a server, the server 1504 may be implemented on a single server, a cluster of servers, a server farm or data center, a cloud hosted computing service, and so forth, although other computer architectures (e.g., a mainframe architecture) may also be used. Further, while the figures illustrate the components of the server 1504 as being present in a single location, it is to be appreciated that these components may be distributed across different computing devices and locations in any manner. Generally, the server 1504 may be implemented by one or more host computing devices, with the various functionality described above distributed in various ways across the different host computing devices. The host computing devices may be located together or separately, and organized, for example, as virtual servers, server banks and/or server farms. The described functionality may be provided by a single entity or enterprise, or may be provided by the multiple entities or enterprises.

As illustrated in FIG. 26, the server 1504 includes one or more processors 2602, one or more computer-readable media 2604, and one or more communication interfaces 2608. The processor(s) 2602 may be a single processing unit or a number of processing units, and may include single or multiple computing units or multiple processing cores. The processor(s) 2602 can be configured to fetch and execute computer-readable instructions stored in the computer-readable media 2604 or other computer-readable media.

The computer-readable media 2604 may be used to store any number of functional components that are executable by the processors 2602. In many implementations, these functional components comprise instructions or programs that are executable by the processors 2602 and that, when executed, implement operational logic for performing the actions attributed above to the server 1504. Functional components of the server 1504 that may be executed on the processors 2602 for implementing the various functions and features related to providing distributed activity discovery and recognition, and cloud storage as described herein, include the activity miner module 1546, the activity discovery module 1548, the activity model 1550, the dynamic adapter 1552, the cloud service 1542, and the recommendation service 1554.

Additional functional components stored in the computer-readable media 2604 may include an operating system 2606 for controlling and managing various functions of the server 1504.

Further, the computer-readable media 2604 may include, or the host computing device(s) 1503 may access, data that may include the user data 1518 and aggregate data 1520. The server 1504 may also include many other logical, programmatic and physical components, of which those described above are merely examples that are related to the discussion herein.

The communication interface(s) 2608 may include one or more interfaces and hardware components for enabling communication with various other devices, such as the controller 1512, over the communication network(s) 1522. For example, communication interface(s) 2608 may facilitate communication through one or more of the Internet, cable networks, cellular networks, wireless networks (e.g., Wi-Fi, cellular) and wired networks. Various different approaches to implementations described herein can be implemented in various environments. For instance, the communication network(s) 1522 may include any suitable network, including an intranet, the Internet, a cellular network, a LAN, WAN, VPN or any other network or combination thereof. Components used for such a system can depend at least in part upon the type of network and/or environment selected. Protocols and components for communicating via such networks are well known and will not be discussed herein in detail.

The server 1504 may further be equipped with various input/output devices 2610. Such I/O devices 2610 may include a display, various user interface controls (e.g., buttons, mouse, keyboard, touch screen, etc.), audio speakers, connection ports and so forth.

Various instructions, methods and techniques described herein may be considered in the general context of computer-executable instructions, such as program modules stored on computer storage media and executed by the processors herein. Generally, program modules include routines, programs, objects, components, data structures, etc., for performing particular tasks or implementing particular abstract data types. These program modules, and the like, may be executed as native code or may be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media.

From the foregoing, it will be appreciated that specific embodiments of the disclosure have been described herein for purposes of illustration, but that various modifications may be made without deviating from the disclosure. Certain aspects of the disclosure described in the context of particular embodiments may be combined or eliminated in other embodiments. Not all embodiments need necessarily exhibit such advantages to fall within the scope of the disclosure. The following examples provide additional embodiments of the disclosure.

We claim:

1. A system, comprising:
a plurality of sensors installed in a space, the sensors being configured to provide first input data;
a control element installed in the space; and
a controller operatively coupled to the sensors and the control element, the controller being programmed to:
recognize an activity of a resident based at least in part on the first input data; and
automate an operation of the control element based at least in part on the recognized activity;
a server operatively coupled to the controller, the server being programmed to:
store data associated with the recognized activity.

2. A system as recited in claim 1, wherein the plurality of sensors include one or more of:
a temperature sensor;
a water flow sensor;
a vibration sensor;
a shake sensor;
an accelerometer; or
a magnetic door closure sensor;

3. A system as recited in claim 1, wherein the server is further programmed to receive the first input data from the one or more sensors via the controller.

4. A system as recited in claim 3, wherein the server is further programmed to:
receive second input data from a second plurality of sensors in a second space via a second controller; and
recognize an activity of the resident based at least in part on the first input data and the second input data.

5. A system as recited in claim 1, further comprising a smart phone programmed to collect second input data and provide the second input data to at least one of the controller or server.

6. A system as recited in claim 1, wherein a plurality of software applications subscribe via a middleware module to information received from one or more sensor devices.

7. A system as recited in claim 1, wherein the controller includes a positional model configured to determine the location of sensors without intervention by the user of the system.

8. A system as recited in claim 1, wherein the controller includes user-selectable fields to input sensor location.

9. The controller as described in claim 8, wherein the user-selectable fields are presented via a secondary computing device able to communicate with the system.

10. The system as recited in claim 1 wherein the user data collected by the system can be uploaded to an aggregate storage space of multiple user data sets.

11. A middleware controller designed to provide communication between the system as recited in claim 1 and sensors, such a middleware-controller comprising at least one of:
a ZigBee Agent;
a synchronization client;
a database loader; or
a storage database.

12. A method comprising:
receiving, by one or more processors of an electronic device, registration requests to join a smart environment from one or more sensor devices;
registering, by middleware, at least one of the sensor devices as a publisher of sensor information;
receiving the sensor information from at least one of the sensor devices;
analyzing the sensor information to determine periodic activity sequences;
generating a first model of activities based at least in part on the periodic activity sequences; and
generating first automation data identifying activities to automate based at least in part on the first model.

13. A method as recited in claim 12, further comprising:
receiving registration requests to join a smart environment from one or more controller devices;
registering, by the middleware, at least one of the controller devices as a subscriber to the first automation data; and
sending the first automation data to at least one of the controller devices.

14. A method as recited in claim 12, further comprising:
sending at least one of the sensor information, the first model of activities, and the first automation data to a server;
receiving second automation data from the server; and
sending the second automation data to at least one of the subscribers of the first automation data.

15. A method as recited in claim 12, further comprising:
sending a message to a portable device indicating the occurrence of an activity and an identifier associated with the activity;
receiving a request for a feature vector associated with the activity from the portable device; and
sending a feature vector associated with the activity to the portable device.

16. A method as recited in claim 15, further comprising:
receiving a message from the portable device indicating the occurrence of the activity; and
adding the activity to the first model of activities.

17. One or more non-transitory computer-readable storage media storing instructions that when executed by one or more processors, cause the one or more processors to perform operations comprising:
admitting a sensor device to a local network within a home;
receiving a request to join a smart environment from the sensor via the local network, wherein the request includes an identifier and a location of the sensor within the home;
storing the identifier and location of the sensor to a registry; and
storing one or more subscriptions to sensor data collected by the sensor in the registry.

18. One or more non-transitory computer-readable storage media as recited in claim 17, the operations further comprising:
admitting a control element device to a local network within a home;
receiving a request to join the smart environment from the control element device via the local network, wherein the request includes an identifier and a location of the control element device within the home; and
storing the identifier and location of the control element device within the home to the registry.

19. One or more non-transitory computer-readable storage media as recited in claim 17, the operations further comprising:
generating a model of activities based at least in part on the sensor data;
generating automation data identifying one or more activities to automate based at least in part on the model; and
determining that the control device element is associated with the automation data, based at least in part on one of the location of the control element device and the location of sensor device; and
sending a message to the control element to automate at least one of the one or more activities.

20. One or more non-transitory computer-readable storage media as recited in claim 19, wherein the sensor and control element include Zigbee devices, and the local network includes a Zigbee mesh network.
